(19) United States
(12) Patent Application Publication
(10) Pub. No.: US 2025/0212091 A1
(43) Pub. Date: Jun. 26, 2025

(54) LOS-Aided TDOA Techniques for Target Localization

(71) Applicant: QUALCOMM Incorporated, San Diego, CA (US)

(72) Inventors: Marwen ZORGUI, San Diego, CA (US); Srinivas YERRAMALLI, San Diego, CA (US); Rajat PRAKASH, San Diego, CA (US); Mohammed Ali Mohammed HIRZALLAH, San Marcos, CA (US)

(21) Appl. No.: 18/396,110

(22) Filed: Dec. 26, 2023

(51) Int. Cl. H04W 40/24; H04W 40/04; H04W 40/20

(52) U.S. Cl. CPC H04W 40/24; H04W 40/04; H04W 40/20

(57) ABSTRACT

A method for configuring a sensing node for a sensing session includes: transmitting one or more target path reporting capability messages indicating a capability of the sensing node to obtain measurements corresponding to one or more target paths that comprise one or more paths of one or more reference signals transmitted by one or more transmitting nodes, reflected by one or more targets, and detected by the sensing node; receiving one or more target path reporting configuration messages to configure the sensing node to obtain one or more target path measurements corresponding to the target path(s); obtaining the target path measurement(s) corresponding to the target path(s) detected by the sensing node without synchronization of a clock of the sensing node with one or more clocks of the transmitting node(s); and transmitting, to a network entity, one or more target path measurement reports corresponding to the target path(s).

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example sensing node includes: one or more memories; a clock; one or more transceivers; and one or more processors, communicatively coupled to the one or more memories and the one or more transceivers. The one or more processors are configured to: transmit, via the one or more transceivers, one or more target path reporting capability messages indicating a capability of the sensing node to obtain measurements corresponding to one or more target paths, where the one or more target paths include one or more paths of one or more reference signals transmitted by one or more transmitting nodes, reflected by one or more targets, and detected by the sensing node; receive, via the one or more transceivers, one or more target path reporting configuration messages to configure the sensing node to obtain one or more target path measurements corresponding to the one or more target paths; obtain the one or more target path measurements corresponding to the one or more target paths without synchronization of the clock of the sensing node with one or more clocks of the one or more transmitting nodes; and transmit, to a network entity via the one or more transceivers, one or more target path measurement reports corresponding to the one or more target paths.

In another example, a method for configuring a sensing node for a sensing session, includes: transmitting one or more target path reporting capability messages indicating a capability of the sensing node to obtain measurements corresponding to one or more target paths, where the one or more target paths comprise one or more paths of one or more reference signals transmitted by one or more transmitting nodes, reflected by one or more targets, and detected by the sensing node; receiving one or more target path reporting configuration messages to configure the sensing node to obtain one or more target path measurements corresponding to the one or more target paths; obtaining the one or more target path measurements corresponding to the one or more target paths detected by the sensing node without synchronization of a clock of the sensing node with one or more clocks of the one or more transmitting nodes; and transmitting, to a network entity, one or more target path measurement reports corresponding to the one or more target paths.

An example network entity, includes: one or more memories; one or more transceivers; and one or more processors, communicatively coupled to the one or more memories and the one or more transceivers, configured to: receive, via the one or more transceivers, one or more target path reporting capability messages from one or more sensing nodes indicating a capability of the one or more sensing nodes to obtain measurements corresponding to one or more target paths, where the one or more target paths include one or more paths of one or more reference signals transmitted by one or more transmitting nodes, reflected by one or more targets, and received by the one or more sensing nodes; transmit, to the one or more sensing nodes via the one or more transceivers, one or more target path reporting configuration messages to configure the one or more sensing nodes to obtain one or more target path measurements corresponding to the one or more target paths; receive, via the one or more transceivers, one or more target path measurement reports corresponding to the one or more target paths from the one or more sensing nodes; and determine one or more positions of the one or more targets using the one or more target path measurement reports corresponding to the one or more target paths without synchronization of a clock of the one or more sensing nodes with one or more clocks of the one or more transmitting nodes.

In another example, a method for determining a position of a target, includes: receiving, from one or more sensing nodes, one or more target path reporting capability messages indicating a capability of the one or more sensing nodes to obtain measurements corresponding to one or more target paths, where the one or more target paths include one or more paths of one or more reference signals transmitted by one or more transmitting nodes, reflected by one or more targets, and received by the one or more sensing nodes; transmitting, to the one or more sensing nodes, one or more target path reporting configuration messages to configure the one or more sensing nodes to obtain one or more target path measurements corresponding to the one or more target paths; receiving, from the one or more sensing nodes, one or more target path measurement reports corresponding to the one or more target paths; and determining one or more positions of the one or more targets using the one or more target path measurement reports corresponding to the one or more target paths without synchronization of a clock of the one or more sensing nodes with one or more clocks of the one or more transmitting nodes.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a simplified block diagram of an example user equipment.

FIG. 6 is a simplified block diagram of an example network entity.

FIG. 7 is a block diagram of a first example configuration of entities in a sensing session according to a first embodiment.

FIG. 8 is a block diagram of a second example configuration of entities in a sensing session according to a first embodiment.

FIG. 9 is a block diagram of a third example configuration of entities in a sensing session according to a first embodiment.

FIG. 10 is a block diagram of a first example configuration of entities in a sensing session according to a second embodiment.

FIG. 11 is a block diagram of a second example configuration of entities in a sensing session according to a second embodiment.

FIG. 12 is a block diagram of a third example configuration of entities in a sensing session according to a second embodiment.

FIG. 13 is a block diagram of a first example configuration of entities in a sensing session according to a third embodiment.

FIG. 14 is a block diagram of a second example configuration of entities in a sensing session according to a third embodiment.

FIG. 15 is a block diagram of a third example configuration of entities in a sensing session according to a third embodiment.

FIG. 16 is an example message flow for configuring a user equipment and a transmission/reception point for a sensing session according to the first, second, or third embodiments.

FIG. 17 is a block flow diagram of an example method for configuring a sensing node for a sensing session.

FIG. 18 is a block flow diagram of an example method for determining a position of a target using one or more target path measurements.

### DETAILED DESCRIPTION

Radio Frequency (RF) sensing techniques may be used to determine a position of a target by measuring reference signals transmitted by a transmitting node, reflected by the target, and received by a sensing node. A combination of one or more transmission/Reception Points (TRP) and one or more user equipment (UE) may be configured for a sensing session for determining the position of each of one or more targets. One or more of the TRP's or one or more of the UE's in a sensing session may be configured as one or more transmitting nodes that transmit reference signals (e.g., an RF signal). One or more of the other TRP's or one or more of the other UE's in the sensing session may be configured as one or more sensing nodes. The one or more sensing nodes are configured to detect and measure one or more target paths corresponding to one or more targets and one or more line of sight (LOS) paths with one or more transmitting nodes. The one or more sensing nodes are further configured to report one or more target path measurements to a network entity. The network entity (e.g., a Sensing Management Function (SnMF)) may use the target path measurements reported by the one or more sensing nodes to determine the positions of one or more targets. In a sensing session, the clocks of the one or more transmitting nodes may be asynchronous with the clocks of the one or more sensing nodes, impacting the accuracy of the target position estimation. To realize greater accuracy, the embodiments described herein leverage LOS paths that exist between entities in the sensing session, such that the target position estimation does not rely on (e.g., may be performed regardless of and/or without respect to) the synchronization of the clocks between the one or more transmitting nodes and the one or more sensing nodes.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

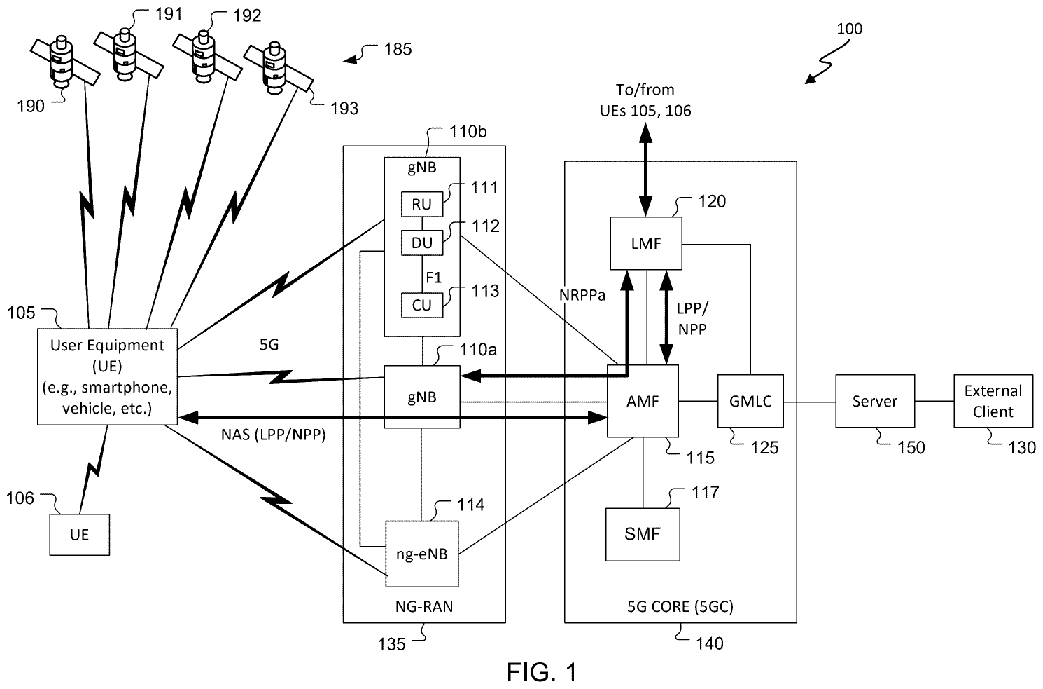

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses, or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share one or more processors but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

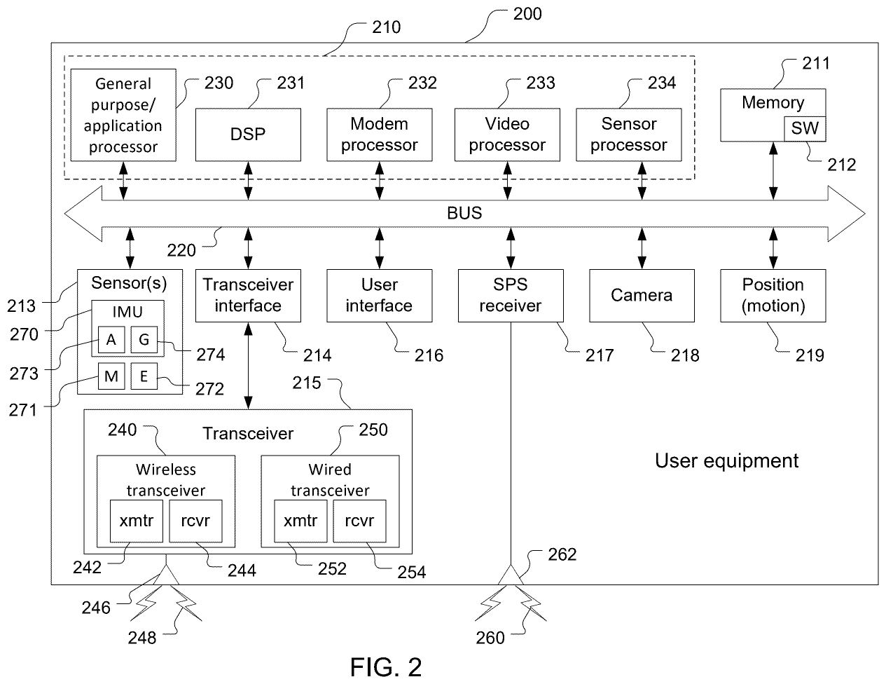

Referring also to FIG. 2, a UE 200 may be an example of one of the UEs 105, 106 and may comprise a computing platform including one or more processors 210, one or more memories 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The one or more processors 210, the one or more memories 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The one or more processors 210 may include one or more intelligent hardware devices, e.g., a central processing unit (CPU), a microcontroller, an application specific integrated circuit (ASIC), etc. The one or more processors 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The one or more memories 211 may be a non-transitory storage medium that may include random access memory (RAM), flash memory, disc memory, and/or read-only memory (ROM), etc. The one or more memories 211 may store the software 212 which may be processor-readable, processor-executable software code containing instructions that may be configured to, when executed, cause the one or more processors 210 to perform various functions described herein. Alternatively, the software 212 may not be directly executable by the one or more processors 210 but may be configured to cause the one or more processors 210, e.g., when compiled and executed, to perform the functions. The description herein may refer to the one or more processors 210 performing a function, but this includes other implementations such as where the one or more processors 210 executes software and/or firmware. The description herein may refer to the one or more processors 210 performing a function as shorthand for one or more of the processors 230-234 performing the function. The description herein may refer to the UE 200 performing a function as shorthand for one or more appropriate components of the UE 200 performing the function. The one or more processors 210 may include one or more memories with stored instructions in addition to and/or instead of the one or more memories 211. Functionality of the one or more processors 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the one or more processors 210, the one or more memories 211, and the wireless transceiver 240. Other example configurations may include one or more of the processors 230-234 of the one or more processors 210, the one or more memories 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the one or more memories 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the one or more processors 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the one or more memories 211 to be processed by DSP 231 and/or the general-purpose/application processor 230 in response to action from a user. Similarly, applications hosted on the UE 200 may store indications of analog and/or digital signals in the one or more memories 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the one or more memories 211, the DSP 231 and/or one or more specialized processors (not shown) may be utilized to process acquired SPS signals, in whole or in part, and/or to calculate an estimated location of the UE 200, in conjunction with the SPS receiver 217. The one or more memories 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the one or more memories 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the one or more processors 210 and the one or more memories 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the one or more processors 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

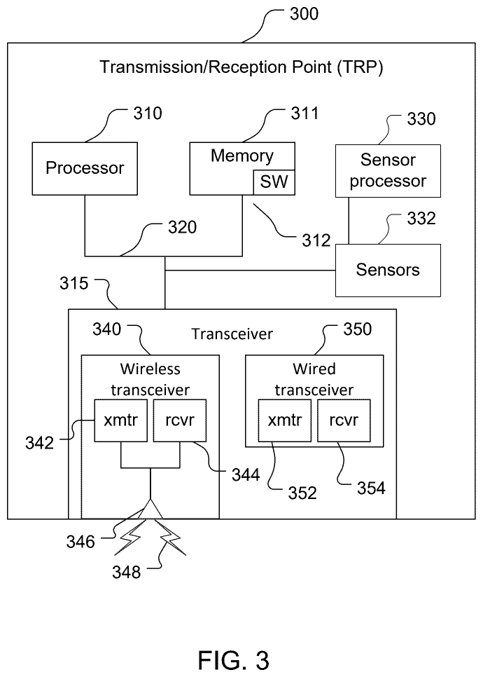

Referring also to FIG. 3, an example of a TRP 300 of the gNBs 110a, 110b and/or the ng-eNB 114 comprises a computing platform including one or more processors 310, one or more memories 311 including software (SW) 312, and a transceiver 315. The one or more processors 310, the one or more memories 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The one or more processors 310 may include one or more intelligent hardware devices, e.g., a central processing unit (CPU), a microcontroller, an application specific integrated circuit (ASIC), etc. The one or more processors 310 may comprise multiple processors (e.g., including a general-purpose/application processor, a DSP, a modem processor, a video processor, and/or a sensor processor as shown in FIG. 2). The one or more memories 311 may be a non-transitory storage medium that may include random access memory (RAM)), flash memory, disc memory, and/or read-only memory (ROM), etc. The one or more memories 311 may store the software 312 which may be processor-readable, processor-executable software code containing instructions that are configured to, when executed, cause the one or more processors 310 to perform various functions described herein. Alternatively, the software 312 may not be directly executable by the one or more processors 310 but may be configured to cause the one or more processors 310, e.g., when compiled and executed, to perform the functions.

The description herein may refer to the one or more processors 310 performing a function, but this includes other implementations such as where the one or more processors 310 executes software and/or firmware. The description herein may refer to the one or more processors 310 performing a function as shorthand for one or more of the processors contained in the one or more processors 310 performing the function. The description herein may refer to the TRP 300 performing a function as shorthand for one or more appropriate components (e.g., the one or more processors 310 and the one or more memories 311) of the TRP 300 (and thus of one of the gNBs 110a, 110b and/or the ng-eNB 114) performing the function. The one or more processors 310 may include one or more memories with stored instructions in addition to and/or instead of the one or more memories 311. Functionality of the one or more processors 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

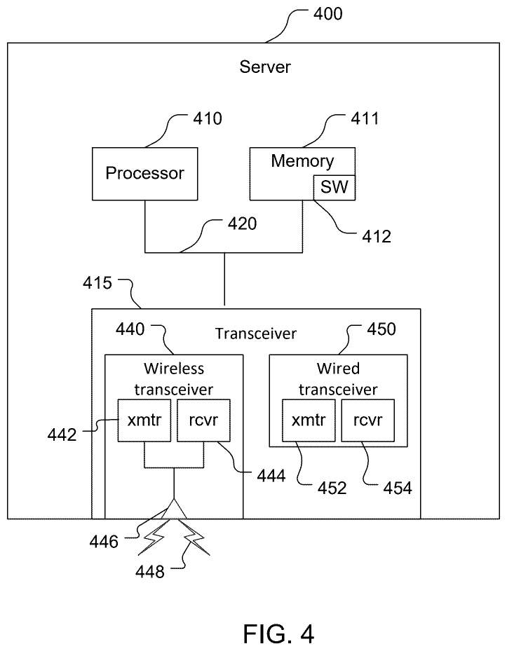

Referring also to FIG. 4, a server 400, of which the LMF 120 may be an example, may comprise a computing platform including one or more processors 410, one or more memories 411 including software (SW) 412, and a transceiver 415. The one or more processors 410, the one or more memories 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The one or more processors 410 may include one or more intelligent hardware devices, e.g., a central processing unit (CPU), a microcontroller, an application specific integrated circuit (ASIC), etc. The one or more processors 410 may comprise multiple processors (e.g., including a general-purpose/application processor, a DSP, a modem processor, a video processor, and/or a sensor processor as shown in FIG. 2). The one or more memories 411 may be a non-transitory storage medium that may include random access memory (RAM)), flash memory, disc memory, and/or read-only memory (ROM), etc. The one or more memories 411 may store the software 412 which may be processor-readable, processor-executable software code containing instructions that are configured to, when executed, cause the one or more processors 410 to perform various functions described herein. Alternatively, the software 412 may not be directly executable by the one or more processors 410 but may be configured to cause the one or more processors 410, e.g., when compiled and executed, to perform the functions. The description herein may refer to the one or more processors 410 performing a function, but this includes other implementations such as where the one or more processors 410 executes software and/or firmware. The description herein may refer to the one or more processors 410 performing a function as shorthand for one or more of the processors contained in the one or more processors 410 performing the function. The description herein may refer to the server 400 performing a function as shorthand for one or more appropriate components of the server 400 performing the function. The one or more processors 410 may include one or more memories with stored instructions in addition to and/or instead of the one or more memories 411. Functionality of the one or more processors 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the one or more processors 410 performing a function, but this includes other implementations such as where the one or more processors 410 executes software (stored in the one or more memories 411) and/or firmware. The description herein may refer to the server 400 performing a function as shorthand for one or more appropriate components (e.g., the one or more processors 410 and the one or more memories 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records,’ one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AOD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nu resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance.” Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

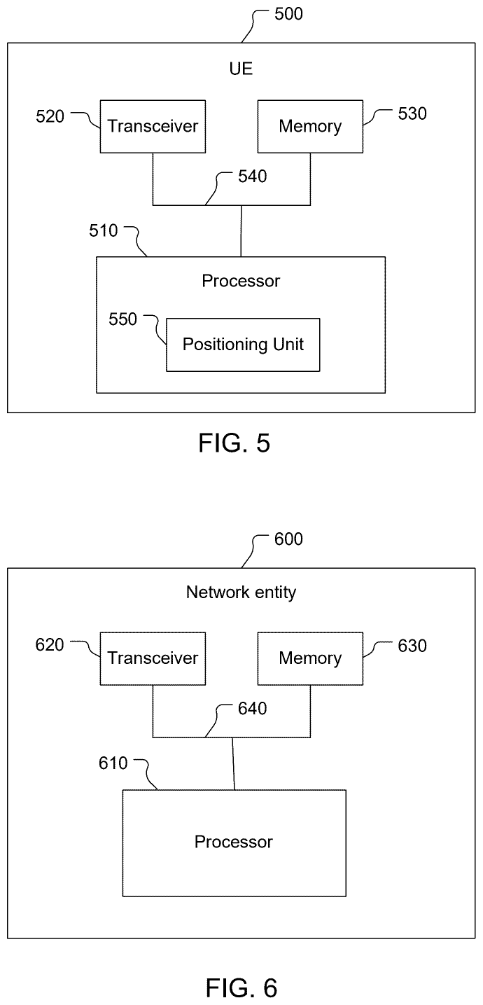

Referring also to FIG. 5, a UE 500 includes one or more processors 510, a transceiver 520, and one or more memories 530 communicatively coupled to each other by a bus 540. Even if referred to in the singular, the one or more processors 510 may include one or more processors, the transceiver 520 may include one or more transceivers (e.g., one or more transmitters and/or one or more receivers), and the one or more memories 530 may include one or more memories. The UE 500 may include the components shown in FIG. 5. The UE 500 may include one or more other components such as any of those shown in FIG. 2 such that the UE 200 may be an example of the UE 500. For example, the one or more processors 510 may include one or more of the components of the one or more processors 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The one or more memories 530 may be configured similarly to the one or more memories 211, e.g., including software with processor-readable instructions configured to cause the one or more processors 510 to perform functions.

The description herein may refer to the one or more processors 510 performing a function, but this includes other implementations such as where the one or more processors 510 executes software (stored in the one or more memories 530) and/or firmware. The description herein may refer to the UE 500 performing a function as shorthand for one or more appropriate components (e.g., the one or more processors 510 and the one or more memories 530) of the UE 500 performing the function. The one or more processors 510 (possibly in conjunction with the one or more memories 530 and, as appropriate, the transceiver 520) may include a positioning unit 550. The positioning unit 550 may be configured to perform positioning operations (e.g., determine position information (e.g., measurements, pseudoranges, position estimates, etc.). The positioning unit 550 may refer to the one or more processors 510 generally, or the UE 500 generally, as performing any of the functions of the positioning unit 550, with the UE 500 being configured to perform the function(s).

Referring also to FIG. 6, a network entity 600 includes one or more processors 610, a transceiver 620, and one or more memories 630 communicatively coupled to each other by a bus 640. Even if referred to in the singular, the network entity 600 may include one or more network entities, the one or more processors 610 may include one or more processors, the transceiver 620 may include one or more transceivers (e.g., one or more transmitters and/or one or more receivers), and the one or more memories 630 may include one or more memories. The network entity 600 may include the components shown in FIG. 6 and may be configured to be a component of a communication network (e.g., a terrestrial communication network such as a cellular network). The network entity 600 may include one or more other components such as any of those shown in FIG. 4 such that the server 400 may be an example of the network entity 600. For example, the one or more processors 610 may include one or more of the components of the one or more processors 410. The transceiver 620 may include one or more of the components of the transceiver 415. The one or more memories 630 may be configured similarly to the one or more memories 411, e.g., including software with processor-readable instructions configured to cause the one or more processors 610 to perform functions. Also or alternatively, the network entity 600 may include one or more other components such as any of those shown in FIG. 3 such that the TRP 300 may be an example of the network entity 600. For example, the one or more processors 610 may include one or more of the components of the one or more processors 310. The transceiver 620 may include one or more of the components of the transceiver 315. The one or more memories 630 may be configured similarly to the one or more memories 311, e.g., including software with processor-readable instructions configured to cause the one or more processors 610 to perform functions.

The description herein may refer to the one or more processors 610 performing a function, but this includes other implementations such as where the one or more processors 610 executes software (stored in the one or more memories 630) and/or firmware. The description herein may refer to the network entity 600 performing a function as shorthand for one or more appropriate components (e.g., the one or more processors 610 and the one or more memories 630) of the network entity 600 performing the function. An example of a network entity 600 includes a sensing management function (SnMF) configured to perform management and coordination of sensing sessions, as described further below. The SnMF may be a standalone network entity or a part of an existing entity, such as the LMF 120, the gNB 110b, or a UE 105 (e.g., a roadside unit).

### Target Position Estimation Using RF Sensing

RF sensing techniques may be used to determine a position of a target by measuring reference signals transmitted by a transmitting node, reflected by the target, and received by a sensing node. A combination of one or more TRP's 300 and one or more UE's 500 may be configured for a sensing session for determining the position of one or more targets. One or more of the TRP's 300 or one or more of the UE's 500 in a sensing session may be configured as one or more transmitting nodes that transmit reference signals (e.g., an RF signal). One or more of the other TRP's 300 or one or more of the other UE's 500 in the sensing session may be configured as one or more sensing nodes. The one or more sensing nodes are configured to detect and measure one or more target paths corresponding to one or more targets and one or more line of sight (LOS) paths with one or more transmitting nodes. The one or more sensing nodes are further configured to report one or more target path measurements to a network entity. An LOS path, as used herein, refers to a path of a reference signal transmitted by a transmitting node and received by a sensing node without interaction(s) with reflection points in the environment. A target path, as used herein, refers to a path of a reference signal transmitted by a transmitting node, reflected by a target, and received by a sensing node. A target path differs from a clutter path, where a clutter path refers to a path which propagates from the transmitting node to the sensing node through interaction(s) with reflection points in the environment that do not belong to the target(s). A sensing node may determine that a detected path is a target path using various techniques, e.g., machine-learning based approaches to differentiate between target paths and clutter paths, or a Moving Target Indicator (MTI) filter (which filters out clutter paths and keeps paths with non-zero Doppler that correspond to moving targets). The network entity (e.g., SnMF 600) may use the target path measurements reported by the one or more sensing nodes to determine the positions of one or more targets. In a sensing session, the clocks of the one or more transmitting nodes may be asynchronous with the clocks of the one or more sensing nodes, impacting the accuracy of the target position estimation. For example, a clock offset may exist between a TRP and a UE due to the fact that the TRP is stationary while the UE is moving. The clock offset may be, for example, several nanoseconds, which may result in an unacceptable margin of error for some applications. For example, a one nanosecond clock offset may translate to a 30 centimeter position error, such that a clock offset of 10 nanoseconds may result in a target position error of approximately three meters. To realize greater accuracy, the embodiments described below do not rely on the synchronization of the clocks between the one or more transmitting nodes and the one or more sensing nodes. The techniques for avoiding reliance on the clock synchronization depends upon the configuration of the one or more transmitting nodes and the one or more sensing nodes in the sensing session, as described further below.

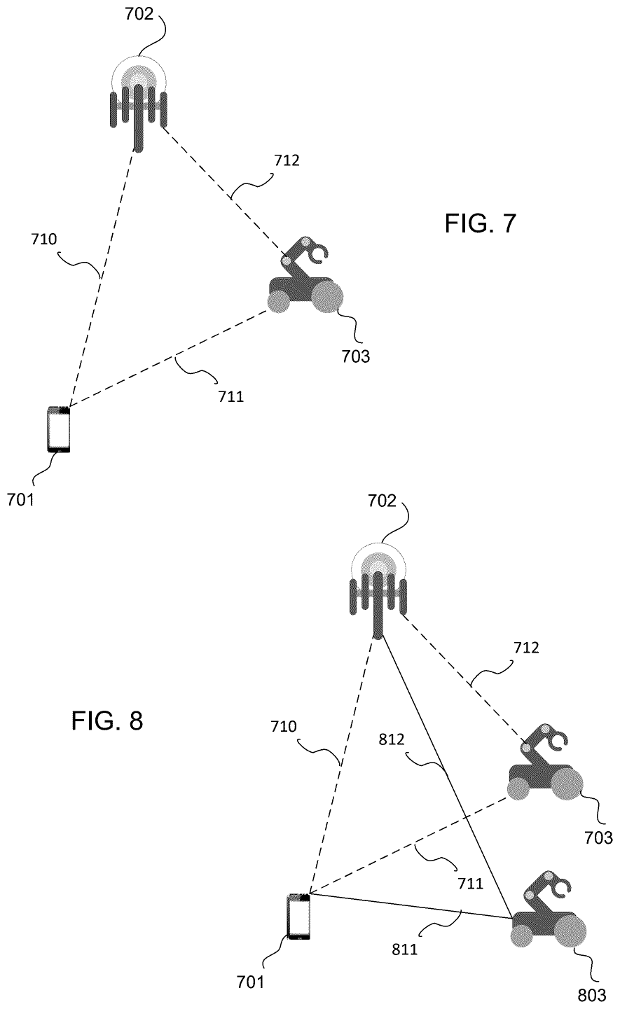

In a first embodiment, shown in FIGS. 7, 8, and 9, a sensing session may be configured to include, for a target path, a transmitting node, a sensing node, and a target observed by the sensing node, where the transmitting node has an LOS with the sensing node. The transmitting node may have a LOS with the target, and the sensing node may have an LOS with the target. The position of the transmitting node and the sensing node are known to the SnMF 600, which may be obtained using RAT or RAT-independent techniques. The position of the target may be determined without relying on clock synchronization between the transmitting node and the sensing node.

Referring to FIG. 7, in a first example of the first embodiment, the SnMF 600 may configure a sensing session where a sensing node detects a single target path (e.g., “observes” the target). The sensing session may include a UE 701 (e.g., UE 500) with a known position P_{UE}, a TRP 702 (e.g., TRP 300) with a known position P_{TRP}, and a target 703 with an unknown position x. The UE 701 may be configured as the transmitting node, and the TRP 702 may be configured as the sensing node, i.e., configured with an uplink (UL) RF signal transmission. An LOS path 710 exists between the UE 701 and the TRP 702, an LOS path 711 exists between the UE 701 and the target 703, and an LOS path 712 exists between the TRP 702 and the target 703. The TRP 702 detects an LOS path 710 and a target path 711, 712 corresponding to the target 703, which includes the combination of the LOS path 711 and the LOS path 712. The TRP 702 may measure the LOS path 710 as:

$${Y}_{UE - TRP} = ‖ {P}_{UE} - {P}_{TRP} ‖ + {δ}_{clock} ( UE , TRP ) \qquad ( Eq . 1 )$$

where
Y_{UE-TRP} represents the LOS path 710,
P_{UE} is the known position of the UE 701,
P_{TRP} is the known position of the TRP 702,
∥P_{UE}-P_{TRP}∥ is the distance between the UE 701 and the TRP 702, and
δ_{clock} (UE, TRP) is the clock offset between the clocks of the UE 701 and the TRP 702, which may contribute to a position error.

### The TRP 702 May Also Detect and Measure the Target Path 711, 712 as:

$${Y}_{UE - target - TRP} = ‖ {P}_{UE} - x ‖ + ‖ {P}_{TRP} - x ‖ + {δ}_{clock} ( UE , TRP ) \qquad ( Eq . 2 )$$

where Y_{UE-target-TRP} represents the target path 711-712,
∥P_{UE}−x∥ is the distance between the UE 701 and the target 703, and
∥P_{TRP}−x∥ is the distance between the TRP 702 and the target 703, and
x is the position of the target 703.

### A Difference Between Eq. 1 and Eq. 2 Results in Eq. 3:

$${Y}_{UE - target - TRP} - {Y}_{UE - TRP} = ‖ {P}_{UE} - x ‖ + ‖ {P}_{TRP} - x ‖ - ‖ {P}_{UE} - {P}_{TRP} ‖ \qquad ( Eq . 3 )$$

where the clock offset, δ_{clock} (UE, TRP), is cancelled out, and which results in an ellipsoid equation where the only unknown is the position x of the target 703. The LOS path 710 between the UE 701 and the TRP 702 is thus leveraged to remove reliance of clock synchronization between the UE 701 and the TRP 702. The target path measurement, Y_{UE-target-TRP}−Y_{UE-TRP}, may be referred herein as a target relative time of arrival (TRTOA), representing a difference or delta between a time a reference signal of the target path 711, 712 arrives at the TRP 702 and the time a reference signal of the LOS path 710 arrives at the TRP 702. The TRP 702, as the sensing node, may measure and report to the SnMF 600 one or more target path measurements that include the TRTOA corresponding to the target 703. Using the reported TRTOA, P_{UE}, and P_{TRP}, the SnMF 600 may derive the position x of the target 703. Additional target path measurements by other TRP's configured as sensing nodes and observing the same target 703 in the sensing session may report additional TRTOA's to the SnMF 600. The SnMF 600 may use the combination of measurements from the TRP's to derive the position x of the target 703. The technique described with reference to FIG. 7 includes an UL signal transmission but may also apply to DL signal transmissions, where the UE 701 may be configured as the sensing node and the TRP 702 may be configured as the transmitting node. For a DL signal transmission, the measurement may be referred to herein as a target reference signal time different (TRSTD).

Referring to FIG. 8, in a second example of the first embodiment, the SnMF 600 may configure a sensing session where a sensing node observes two different target paths corresponding to two different targets. The sensing session may include a UE 701 with a known position P_{UE}, a TRP 702 with a known position P_{TRP}, a first target 703 with a first unknown position x₁, and a second target 803 with a second unknown position x₂. The UE 701 may be configured as the transmitting node, and the TRP 702 may be configured as the sensing node, i.e., configured with an uplink (UL) RF signal transmission. The TRP 702 may detect the LOS path 710 and two target paths, a first target path 711, 712 corresponding to the first target 703 (Y_{1,UE-target-TRP}) and a second target path 811, 812 corresponding to the second target 803 (Y_{2,UE-target-TRP}). For the UE 701, an LOS path 710 exists with the TRP 702, an LOS path 711 exists the first target 703, and an LOS path 811 exists with the second target 703. For the TRP 702, an LOS path 712 exists with the first target 703, and an LOS path 812 exists with the second target 803. The TRP 702 detects the first target path 711, 712 corresponding to the first target 703, which includes the LOS path 711 and the LOS path 712. The TRP 702 also detects a second target path 811, 812 corresponding to the second target 803, which includes the LOS path 811 and the LOS path 812. The TRP 702 may measure the TRTOA for both the detected first and second target paths as:

$${TRTOA}_{1} = {Y}_{1 , UE - target - TRP} - {Y}_{UE - TRP} , and \qquad ( Eq . 4 )$$

$${TRTOA}_{2} = {Y}_{2 , UE - target - TRP} - {Y}_{UE - TRP} . \qquad ( Eq . 5 )$$

### A Difference Between Eq. 4 and E1.5 Results in Eq. 6:

$${TRTOA}_{2} = {TRTOA}_{1} + ( {Y}_{2 , UE - target - TRP} - {Y}_{1 , UE - target - TRP} ) \qquad ( Eq . 6 )$$

where (Y_{2,UE-target-TRP}−Y_{1,UE-target-TRP}) represents the difference or delta between a time a reference signal of the first target path 711, 712 arrives at the TRP 702 and a time a reference signal of the second target path 811, 812 arrives at the TRP 702, referred to herein as a target path relative time delay (TRTD). The TRP 702 may be configured to report TRTOA₁ and TRTD to the SnMF 600, instead of reporting TRTOA₁ and TRTOA₂ in order to save network resources since the TRTD includes fewer bits than the TRTOA₁. Using the TRTOA and the TRTD, the SnMF 600 may construct TRTOA₂. By using multiple reported TRTOA's and TRTD's corresponding to the first and second targets 703, 803, and using the known positions of the UE 701 (P_{UE}) and the TRP 702 (P_{TRP}), the SnMF 600 may derive the position x₁ of the first target 703 using TRTOA₁ and may derive position x₂ of the second target 803 using the constructed TRTOA₂. The same technique may be repeated for target paths corresponding to additional target paths detected by the TRP 702, where the TRP 702 may report the TRTD corresponding to each additional target path observed by the TRP 702. The technique described for an UL signal transmission may also apply to DL signal transmissions, where the UE 701 may be configured as the sensing node and the TRP 702 may be configured as the transmitting node.

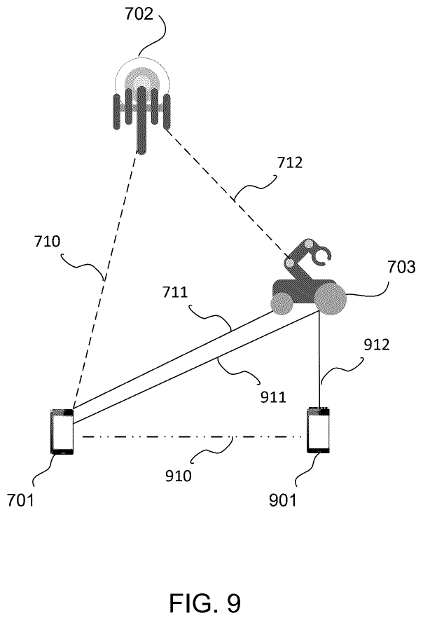

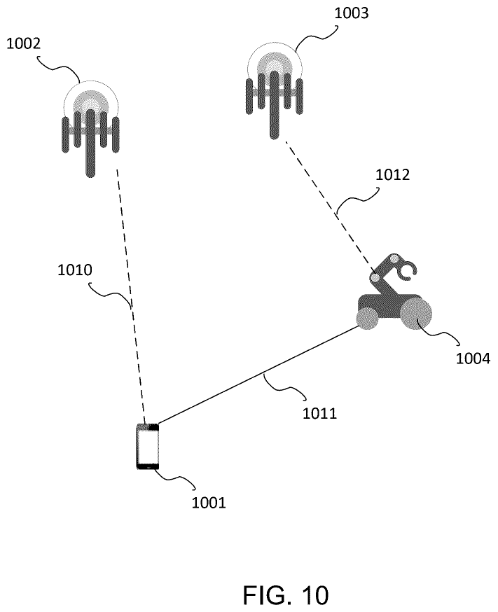

Referring to FIG. 9, in a third example of the first embodiment, the SnMF 600 may configure a sensing session that includes a combination of one or more UL/DL transmissions and one or more SL transmissions. The sensing session may include a first UE 701 with a known position P_{UE1}, a second UE 901 with a known position P_{UE2}, a TRP 702 with a known position P_{TRP}, and a target 703 with an unknown position x. The first UE 701 may be configured as the transmitting node for a UL transmission to the TRP 702 as a first sensing node. The first UE 701 may also be configured as the transmitting node for a SL transmission to the second UE 901 as a second sensing node, where the TRP 702 and the second UE 901 observe the same target 703. For the first UE 701, an LOS path 710 exists with the TRP 702, a first LOS path 711 exists with the target 703, a second LOS path 911 exists with the target 703, and an LOS path 910 exists with the second UE 901. For the second UE 901, an LOS path 912 exists with the target 703, and an LOS path 712 exists with the target 703. The TRP 702 may detect a first target path 711, 712 corresponding to the target 703, which includes the LOS path 711 and the LOS path 712. The second UE 901 may detect a second target path 911, 912 corresponding to the target 703, which includes the LOS path 911 and the LOS path 912. The TRP 702 may measure TRTOA₁ (Eq. 4) for the first target path 711, 712, as described above with reference to FIG. 8. The second UE 901 may detect and measure the LOS path 910 as:

$${Y}_{UE 1 - UE 2} = ‖ {P}_{UE 1} - {P}_{UE 2} ‖ + {δ}_{clock} ( UE 1 , UE 2 ) \qquad ( Eq . 7 )$$

where
Y_{UE1-UE2} represents the LOS path 910,
P_{UE1} is the known position of the first UE 701,
P_{UE2} is the known position of the second UE 901,
∥P_{UE1}−P_{UE2}∥ is the distance between the first UE 701 and the second UE 901, and
δ_{clock} (UE1, UE2) is the clock offset between the clocks of the first UE 701 and the second UE 901, which may contribute to a position error.
   The second UE 901 may detect and measure the target path 911, 912 as:

$${Y}_{UE 1 - target - UE 2} = ‖ {P}_{UE 1} - x ‖ + ‖ {P}_{UE 2} - x ‖ + {δ}_{clock} ( UE 1 , UE 2 ) \qquad ( Eq . 8 )$$

where
Y_{UE1-target-UE2} represents the target path 911, 912,
∥P_{UE1}−x∥ is the distance between the first UE 701 and the target 703,
∥P_{UE2}−x∥ is the distance between the second UE 901 and the target 703,
δ_{clock} (UE1, UE2) is the clock offset between the clocks of the first UE 701 and the second UE 901, which may contribute to a position error, and
x is the position of the target 703.

A difference between Ep. 7 and Eq. 8 results in Eq. 9:

$${Y}_{UE 1 - target - UE 2} - {Y}_{UE 1 - UE 2} = ‖ {P}_{UE 1} - x ‖ + ‖ {P}_{UE 2} - x ‖ - ‖ {P}_{UE 1} - {P}_{UE 2} ‖ \qquad ( Eq . 9 )$$

where the clock offset, δ_{clock}(UE1, UE2), is cancelled out, and which results in an ellipsoid equation where the only unknown is the position x of the target 703. The target path measurement, Y_{UE1-target-UE2}−Y_{UE1-UE2}, may be referred herein as TRTOA₃, representing a difference or delta between a time a reference signal of the target path 911, 912 arrives at the second UE 901 and the time a reference signal of the LOS path 910 arrives at the second UE 901. The second UE 901, as the sensing node, may measure and report to the SnMF 600 the TRTOA₃ corresponding to the target 703. The SnMF 600 may receive reports of TRTOA₁ from the TRP 702 and TRTOA₃ from the second UE 901. Using the reported TRTOA₁ and TRTOA₃, and using the known positions of the first UE 701 (P_{UE1}), the second UE 901 (P_{UE2}), and the TRP 702 (P_{TRP}), the SnMF 600 may derive the position x of the target 703. If the second UE 901 is observing additional target(s) using sensing signals from the same transmitting node, the SnMF 600 may configure the second UE 901 to report where a combination of TRTOA and TRTD measurements corresponding to the additional target(s), as described above with reference to FIG. 8, and which may be used by the SnMF 600 to determine the position x of the target 703.

In a second embodiment, shown in FIGS. 10, 11, and 12, a sensing session may be configured to include, for a target path, a transmitting node, a target, an observing sensing node directly observing the target, and a reference sensing node that does not directly observe the target. The observing sensing node may have an LOS with the target but no LOS with the transmitting node. The reference sensing node may not have an LOS with the target and has a LOS with the transmitting node. The positions of the transmitting node, the observing sensing node, and the reference sensing node are known. The clocks of the observing and reference sensing nodes are synchronized. The position of the target may be determined without relying on the synchronization between the clock of the transmitting node and the clocks of the observing or reference sensing nodes.

Referring to FIG. 10, in a first example of the second embodiment, the SnMF 600 may configure a sensing session where the observing sensing node observes a single target. The sensing session may include a UE 1001 with a known position P_{UE}, a first TRP (TRP₁) 1003 with a known position P_{TRP1}, a second TRP (TRP_{ref}) 1002 with a known position P_{TRPref}, and a target 1004 with an unknown position x. The UE 1001 may be configured as the transmitting node, the TRP₁ 1003 may be configured as the observing sensing node, and the TRP_{ref} 1002 may be configured as the reference sensing node. The UE 1001 has an LOS with TRP_{ref} 1002 and the target 1004, but no LOS with TRP₁ 1003 that is observing the target 1004. TRP₁ 1003 has an LOS with the target 1004 but no LOS with the UE 1001. An LOS path 1010 exists between the UE 1001 and TRP_{ref} 1002, an LOS path 1011 exists between the UE 1001, and an LOS path 1012 exists between TRP_{ref} 1002 and the target 1004. The TRP₁ 1003 may detect a target path 1011, 1012 corresponding to the target 1004, which includes LOS path 1011 and LOS path 1012. The TRP₁ 1003 may measure the target path 1011, 1012 as:

$${Y}_{UE - target - {TRP}_{1}} = ‖ {P}_{UE} - x ‖ + ‖ {P}_{{TRP}_{1}} - x ‖ + {δ}_{clock} ( UE , {TRP}_{1} ) \qquad ( Eq . 10 )$$

where
Y_{UE-target-TRP}_{₁} represents the target path 1011, 1012,
P_{UE} is the known position of the UE 1001,
P_{TRP}_{₁} is the known position of TRP₁ 1003,
∥P_{UE}−x∥ is the distance between the UE 1001 and the target 1004, corresponding to LOS path 1011,
∥P_{TRP}_{₁}−x∥ is the distance between TRP₁ 1003 and the target 1004, corresponding to LOS path 1012,
δ_{clock} (UE, TRP₁) is the clock offset between the UE 1001 and TRP₁ 1003, which may contribute to a position error, and
x is the unknown position of the target 1004.

### TRP_{ref} 1002 Measures the LOS Path 1010 as:

$${Y}_{UE - {TRP}_{ref}} = ‖ {P}_{UE} - {P}_{{TRP}_{ref}} ‖ + {δ}_{clock} ( UE , {TRP}_{ref} ) \qquad ( Eq . 11 )$$

where
Y_{UE-TRP}_{_{ref}} represents the LOS path 1010,
P_{TRP}_{_{ref}} is the known position of the TRP_{ref} 1002,
P_{UE}−P_{TRP}_{_{ref}} is the distance between the UE 1001 and TRP_{ref} 1002, and
δ_{clock} (UE, TRP_{ref}) is the clock offset between the clocks of the UE 1001 and
   TRP_{ref} 1002, which may contribute to a position error.

The second embodiment does not rely on the synchronization of the clocks between the UE 1001 and the TRP₁ 1003, but relies on the synchronization between the clocks of the TRP₁ 1003 and the TRP_{ref} 1002. A difference between Eq. 10 and Eq. 11 results in Eq. 12:

$${Y}_{UE - target - {TRP}_{1}} - {Y}_{UE - {TRP}_{ref}} = ‖ {P}_{UE} - x ‖ + ‖ {P}_{{TRP}_{1}} - x ‖ - ‖ {P}_{UE} - {P}_{{TRP}_{ref}} ‖ \qquad ( Eq . 12 )$$

Since the clocks of TRP_{ref} 1002 and TRP₁ 1003 are synchronized, δ_{clock}(UE, TRP₁)=δ_{clock} (UE, TRP_{ref}), and the clock offsets are cancelled out in Eq. 12. The target path measurement, Y_{UE-target-TRP}_{₁}−Y_{UE-TRP}_{_{ref}}, may be referred to as an LOS-aided target relative time of arrival (TRTOA (LOS)). The measurements of the LOS path 1010 obtained TRP_{ref} 1002, which has an LOS with the UE 1001, are used with the target path measurements obtained by TRP₁ 1003, which does not have an LOS with the UE 1001, to cancel out the clock offsets in Eq. 12. The TRTOA (LOS) represents a difference or delta between a time a sensing signal of the target path 1011, 1012 arrives at the TRP₁ 1003 and a time a sensing signal of the LOS path 1010 arrives at the TRP_{ref} 1002. Eq. 12 may be expressed as:

$${TRTOA}^{\{ LOS \}} + ‖ {P}_{UE} - {P}_{{TRP}_{ref}} ‖ = ‖ {P}_{UE} - x ‖ + ‖ {P}_{{TRP}_{1}} - x ‖ \qquad ( Eq . 13 )$$

which results in an ellipsoid equation where the only unknown is the position x of the target 1004. Using the reported TRTOA (LOS) corresponding to the target 1004, and using the known positions of the UE 1001 (P_{UE}), the TRP_{ref} 1002 (P_{TRPref}), and the TRP₁ 1003 (P_{TRP1}), the SnMF 600 may derive the position x of the target 1004. The techniques described with reference to FIG. 10 for an UL signal transmission also applies to DL signal transmissions, where a TRP may be configured as the transmitting node, a first UE may be configured as a reference sensing node, and a second UE may be configured as an observing sensing nodes. For a DL signal transmission, the measurement may be referred to as an LOS-assisted target reference signal time different (TRSTD^{{LOS}}.

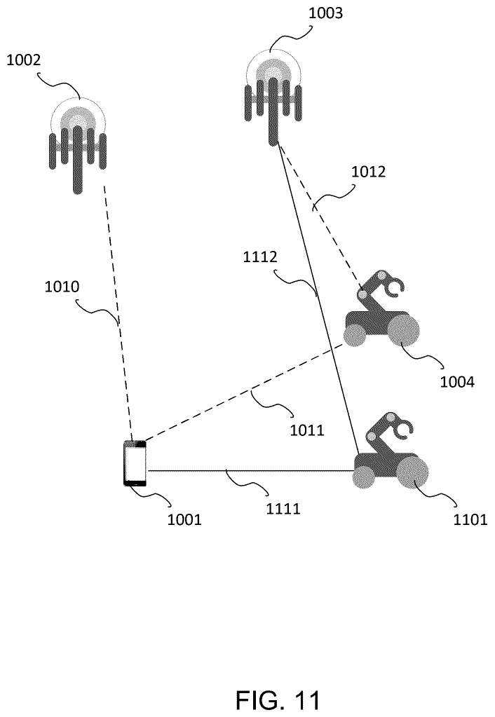

Referring to FIG. 11, in a second example of the second embodiment, the SnMF 600 may configure a sensing session where the observing sensing node observes two different targets. The sensing session may include a UE 1001 with a known position P_{UE}, a first TRP (TRP₁) 1003 with a known position P_{TRP1}, a second TRP (TRP_{ref}) 1002 with a known position P_{TRPref}, a first target 1004 with a first unknown position x₁, and a second target 1101 with a second unknown position x₂. The UE 1001 may be configured as the transmitting node, the TRP₁ 1003 may be configured as the observing sensing node, and the TRP_{ref} 1002 may be configured as the reference sensing node. The UE 1001 has an LOS with TRP_{ref} 1002, an LOS with the first target 1004, and an LOS with the second target 1101, but no LOS with TRP₁ 1003. The TRP₁ 1003 has an LOS with the first target 1004 and the second target 1101, but no LOS with the UE 1001. TRP_{ref} 1002 has an LOS with the UE 1111 but no LOS with TRP₁ 1003 and no LOS with either target 1004, 1101. In addition to the LOS paths 1010, 1011, and 1012, an LOS path 1111 exists between the UE 1001 and the second target 1101, and an LOS path 1112 exists between TRP₁ 1003 and the target 1011. The TRP₁ 1003 may detect two target paths, including: a target path 1011, 1012 corresponding to the first target 1004, which includes LOS path 1011 and LOS path 1012; and a target path 1111, 1112 corresponding to the second target 1101, which includes LOS path 1111 and LOS path 1112. The two target paths may be measured as:

$${Y}_{UE - target 1 - {TRP}_{1}} = ‖ {P}_{UE} - {x}_{1} ‖ + ‖ {P}_{{TRP}_{1}} - {x}_{1} ‖ + {δ}_{clock} ( UE , {TRP}_{1} ) and \qquad ( Eq . 14 )$$

$${Y}_{UE - target 2 - {TRP}_{1}} = ‖ {P}_{UE} - {x}_{2} ‖ + ‖ {P}_{{TRP}_{1}} - {x}_{2} ‖ + {δ}_{clock} ( UE , {TRP}_{1} ) , \qquad ( Eq . 15 )$$

where
Y_{UE-target1-TRP}_{₁} represents the target path 1011, 1012 corresponding to the first target 1004,
Y_{UE-target2-TRP}_{₁} represents the target path 1111, 1112 corresponding to the second target 1101,
P_{UE} is the known position of the UE 1001,
P_{TRP}_{₁} is the known position of TRP₁ 1003,
∥P_{UE}−x₁∥ is the distance between the UE 1001 and the first target 1004, corresponding to LOS path 1011,
∥P_{TRP}_{₁}−x₁∥ is the distance between TRP₁ 1003 and the first target 1004, corresponding to LOS path 1012,
∥P_{UE}−x₂∥ is the distance between the UE 1001 and the second target 1101, corresponding to LOS path 1111,
∥P_{TRP}_{₁}−x₂∥ is the distance between TRP₁ 1003 and the second target 1101, corresponding to LOS path 1112,
δ_{clock} (UE, TRP₁) is the clock offset between the UE 1001 and TRP₁ 1003, which may contribute to a position error,
x₁ is the unknown position of the first target 1004, and
x₂ is the unknown position of the second target 1101.
   TRP_{ref} 1002 measures the LOS path 1010 as set forth above in Eq. 11. A difference between Eq. 11 and 14 results in Eq. 16:

$${Y}_{UE - target 1 - {TRP}_{1}} - {Y}_{UE - {TRP}_{ref}} = ‖ {P}_{UE} - {x}_{1} ‖ + ‖ {P}_{{TRP}_{1}} - {x}_{1} ‖ - ‖ {P}_{UE} - {P}_{{TRP}_{ref}} ‖ = {TRTOA}_{1}^{\{ LOS \}} \qquad ( Eq . 16 )$$

### A Difference Between Eq. 11 and Eq. 15 Results in Eq. 17:

$${Y}_{UE - target 2 - {TRP}_{1}} - {Y}_{UE - {TRP}_{ref}} = ‖ {P}_{UE} - {x}_{2} ‖ + ‖ {P}_{{TRP}_{1}} - {x}_{2} ‖ - ‖ {P}_{UE} - {P}_{{TRP}_{ref}} ‖ = {TRTOA}_{2}^{\{ LOS \}} \qquad ( Eq . 17 )$$

In both Eqs. 16 and 17, the clock offsets (δ_{clock}(UE, TRP₁)) are cancelled out. A difference between TRTOA₂^{{LOS}} and TRTOA₁^{{LOS}} may be expressed as:

$${TRTOA}_{2}^{\{ LOS \}} - {TRTOA}_{1}^{\{ LOS \}} = {Y}_{UE - target 1 - {TRP}_{1}} - {Y}_{UE - target 2 - {TRP}_{1}} , or \\ {TRTOA}_{2}^{\{ LOS \}} = {TRTOA}_{1}^{\{ LOS \}} + ( {Y}_{UE - target 1 - {TRP}_{1}} - {Y}_{UE - target 2 - {TRP}_{1}} ) \qquad ( Eq . 18 )$$

where (Y_{UE-target1-TRP}_{₁}−Y_{UE-target2-TRP}_{₁}) is the LOS-assisted TRTD or TRTD^{{LOS}}. TRTD^{{LOS}} represents the difference or delta between a time when the target path 1011-1012 arrives at TRP₁ 1003 and a time when the target path 1111-1112 arrives at TRP₁ 1003. To save network resources, the TRP₁ 1003 may be configured to report TRTOA₁^{{LOS}} and the TRTD^{{LOS}} to the SnMF 600, instead of reporting TRTOA 1 (LOS) and TRTOA₂^{{LOS}}. Using TRTOA₁^{{LOS}} and the TRTD^{{LOS}} reported by TRP₁ 1003, the SnMF 600 may construct TRTOA₂^{{LOS}}. By using multiple reported TRTOAᵢ^{{LOS}}'s and TRTD^{{LOS}}'s corresponding to the first and second targets 1004, 1101, and using the known positions of the UE 1001 (P_{UE}), TRP_{ref} 1002 (P_{TRPref}), and TRP₁ (P_{TRP1}) 1003, the SnMF 600 may derive the position x₁ of the first target 1004 using TRTOA₁^{{LOS}} and may derive position x₂ of the second target 803 using the constructed TRTOA₂^{{LOS}}. The same technique may be used for target paths corresponding to additional target paths detected by TRP₁ 1003, where TRP₁ 1003 may report the TRTDᵢ^{{LOS}} corresponding to the additional target paths. The techniques described with reference to FIG. 11 for an UL signal transmission may also applies to DL signal transmissions, where a TRP may be configured as the transmitting node, and two UE's may be configured as the sensing nodes (one UE configured as an observing sensing node and the other UE configured as a reference sensing node). For a DL signal transmission, the measurement may be referred to as an LOS-assisted target reference signal time different (TRSTD^{{LOS}}). The same technique may be applied to SL transmissions between UE's. For example, a group of clock-synchronized UEs (e.g., roadside UEs) may be configured as reference sensing nodes and observing sensing nodes, while non-clock-synchronized UEs may be configured as transmitting nodes.

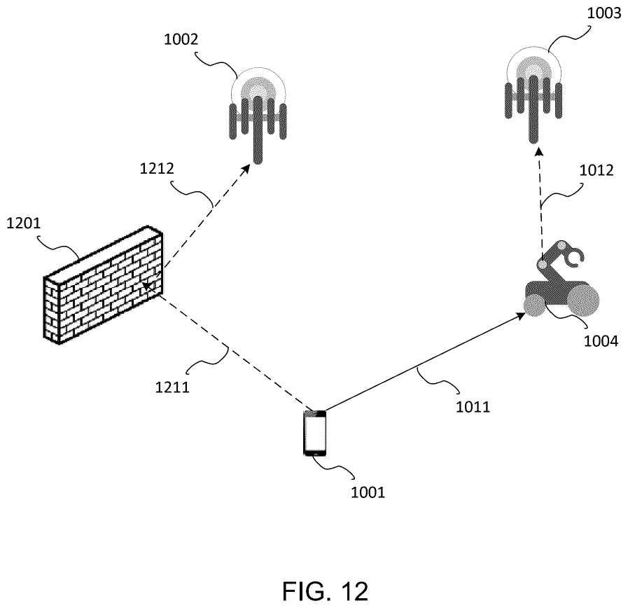

Referring to FIG. 12, in a third example of the second embodiment, the sensing session may be configured as in FIG. 10, except the UE 1001 has no LOS with TRP_{ref} 1002. Instead, the UE 1001 and TRP_{ref} 1002 has an LOS with a reflector 1201, where the position of the reflector 1201 (P_{reflector}) is known. An LOS path 1211 exists between the UE 1001 and the reflector 1201 (∥P_{reflectcor}−P_{UE}∥), and an LOS path 1212 exists between the reflector 1201 and TRP_{ref} 1002 (∥P_{reflectcor}−P_{TRPref}∥). The signaling between TRP_{ref} 1002 and the UE 1001, as described with reference to FIGS. 10 and 11, may be replaced with the signaling between the reflector 1201 and TRP_{ref} 1002 in combination with the signaling between the reflector 1201 and the UE 1001. For example, each instance of P_{TRPref} in Eqs. 11, 12, and 13 may be replaced with (∥P_{reflectcor}−P_{UE}∥+∥P_{reflectcor}−P_{TRPref}∥). In this third example, the reference sensing node (e.g., TRP_{ref}) may be used to estimate the clock offset, δ_{clock}. If a sensing session is configured with N TRPs observing the same target, and one of the TRPs is configured as TRP_{ref}, then N ellipsoid equations of the type in Eq. 13 can be derived, which may be used by the SnMF 600 to determine a position of the target 1004. Further in this third example, for a sensing session configured with multiple UE's, a different TRP may be configured as the reference sensing node, TRP_{ref}, for each UE.

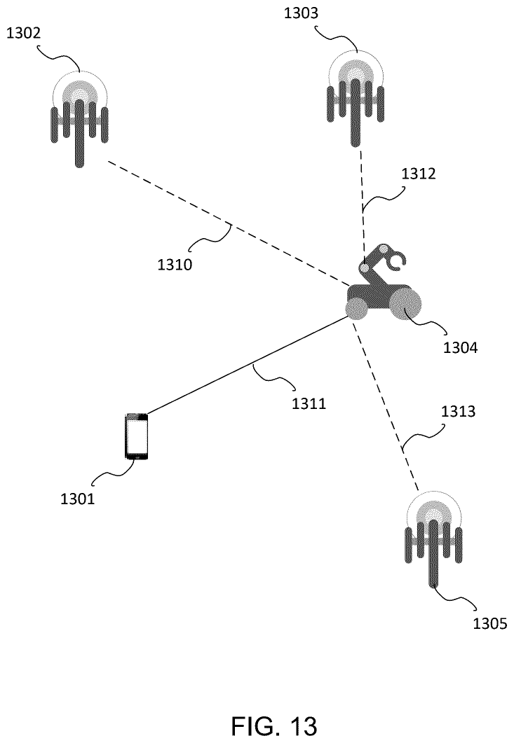

In a third embodiment, shown in FIGS. 13, 14, and 15, a sensing session may be configured to include, for a target path, a target, a transmitting node, an observing sensing node, and a reference sensing node, where both the observing and reference sensing nodes directly observe one or more targets. The observing sensing node, the reference sensing node, and the transmitting node each may have an LOS with the target but no LOS with each other. The positions of the observing and reference sensing nodes are known, and the clocks of the observing and reference sensing nodes are synchronized. In the third embodiment, the position of the target may be determined independent of the position of the transmitting node and without relying on an LOS between the transmitting node and the observing sensing node or on an LOS between the transmitting node and the reference sensing node.

Referring to FIG. 13, in a first example of the third embodiment, the SnMF 600 may configure a sensing session, where the observing sensing node and the reference sending node observe the same target. The sensing session includes a UE 1301 with a known or unknown position P_{UE}, a first TRP (TRP₁) 1303 with a known position P_{TRP1}, a second TRP (TRP_{ref}) 1302 with a known position P_{TRPref}, and a target 1304 with an unknown position x. The UE 1301 may be configured as the transmitting node, TRP₁ 1303 may be configured as the observing sensing node, and TRP_{ref} 1302 may be configured as the reference sensing node. The UE 1301 has an LOS with the target 1304 but no LOS with TRP_{ref} 1302 or TRP₁ 1303. TRP_{ref} 1302 and TRP₁ 1303 each has an LOS with the target 1304 but no LOS with the UE 1301 or with each other. TRP_{ref} 1302 may detect and measure a target path 1311, 1310 corresponding to the target 1304, which includes LOS path 1311 and LOS path 1301, as:

$${Y}_{UE - target - {TRP}_{ref}} = ‖ {P}_{UE} - x ‖ + ‖ {P}_{{TRP}_{ref}} - x ‖ + {δ}_{clock} ( UE , {TRP}_{ref} ) \qquad ( Eq . 19 )$$

where
Y_{UE-target-TRP}_{_{ref}} represents the target path 1311, 1310,
P_{UE} is known or unknown position of the UE 1301,
P_{TRPref} is the known position of the TRP_{ref} 1302,
∥P_{UE}−x∥ is the distance between the UE 1301 and the target 1304, corresponding to LOS path 1311,
∥P_{TRP}_{_{ref}}−x∥ is the distance between TRP_{ref} 1302 and the target 1304, corresponding to LOS path 1310, and
δ_{clock} (UE, TRP_{ref}) is the clock offset between the UE 1301 and TRP_{ref} 1302.
   Similarly, TRP₁ 1303 may detect and measure a target path 1311, 1312 corresponding to the target 1304, which includes LOS path 1311 and LOS path 1312, as:

$${Y}_{UE - target - {TRP}_{1}} = ‖ {P}_{UE} - x ‖ + ‖ {P}_{{TRP}_{1}} - x ‖ + {δ}_{clock} ( UE , {TRP}_{1} ) \qquad ( Eq . 20 )$$

where Y_{UE-target-TRP}_{₁} represents the target path 1311, 1312,
P_{UE} is the known or unknown position of the UE 1301,
P_{TRP}, is the known position of the TRP₁ 1303,
∥P_{UE}−x| is the distance between the UE 1301 and target 1304, corresponding to LOS path 1311,
∥P_{TRP}_{₁}−x∥ is the distance between TRP₁ 1303 and the target 1304, corresponding to LOS path 1312, and
δ_{clock}(UE, TRP₁) is the clock offset between the UE 1301 and TRP₁ 1303.

### A Difference Between Eq. 19 and Eq. 20 Results in Eq. 21:

$${Y}_{UE - target - {TRP}_{1}} - {Y}_{UE - target - {TRP}_{ref}} = ( ‖ {P}_{UE} - x ‖ + ‖ {P}_{{TRP}_{1}} - x ‖ + {δ}_{clock} ( UE , {TRP}_{1} ) ) - ( ‖ {P}_{UE} - x ‖ + ‖ {P}_{{TRP}_{ref}} - x ‖ + {δ}_{clock} ( UE , {TRP}_{ref} ) ) , or \\ {Y}_{UE - target - {TRP}_{1}} - {Y}_{UE - target - {TRP}_{ref}} = ‖ {P}_{{TRP}_{1}} - x ‖ - ‖ {P}_{{TRP}_{ref}} - x ‖ \qquad ( Eq . 21 )$$

where the position of the UE 1301, P_{UE}, is cancelled out. Since the clocks of TRP_{ref} 1302 and TRP₁ 1303 are synchronized, δ_{clock}(UE, TRP_{ref}) and δ_{clock}(UE, TRP₁) have the same value and are also cancelled out. Eq. 21 is a hyperbola where the only unknown is the position x of the target 1304. The target path measurement, Y_{UE-target-TRP}_{₁}−Y_{UE-target-TRP}_{_{ref}}, may be referred to as the target relative time of arrival (TRTOA (TRPᵢ, UE, TRP_{ref})). Using similar target path measurements from other observing TRP's, such as TRP 1305 with an LOS path 1313 with the target 1304, the SnMF 600 may derive multiple equations of type Eq. 21 and use the derived equations to determine the position x of the target 1304. The same technique may be applied to DL and SL transmissions.

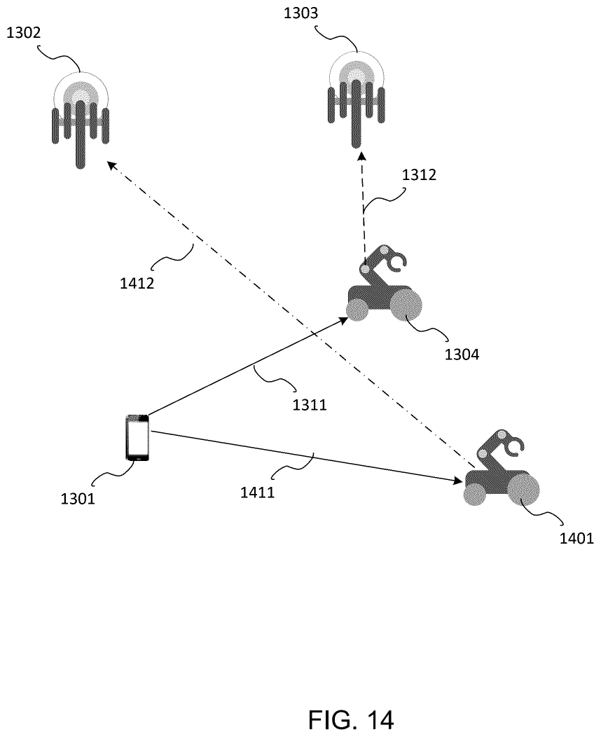

Referring to FIG. 14, in a second example of the third embodiment, the SnMF 600 may configure a sensing session where the observing sensing node and the reference sensing node observe different targets. The sensing session may include the UE 1301 with known or unknown position P_{UE}, the first TRP (TRP₁) 1303 with a known position P_{TRP1}, the second TRP (TRP_{ref}) 1302 with a known position P_{TRPref}, a first target 1304 with an unknown position x₁, and a second target 1401 with an unknown position x₂. The UE 1301 may be configured as the transmitting node, TRP₁ 1303 may be configured as the observing sensing node that observes the first target 1304 but not the second target 1401, and TRP_{ref} 1302 may be configured as the reference sensing node that observes the second target 1401 but not the first target 1304. The UE 1301 has an LOS with the first target 1304 and the second target 1401, but no LOS with TRP_{ref} 1302 or TRP₁ 1303. TRP₁ 1303 has an LOS with the first target 1304 but no LOS with the UE 1301 or the second target 1401. TRP_{ref} 1302 has an LOS with the second target 1401 but no LOS with the UE 1301 or the first target 1304. TRP₁ 1303 detects and measures a first target path 1311, 1312 (Y_{UE-target-TRP}_{₁}) corresponding to the first target 1304, which includes LOS path 1311 and LOS path 1312. TRP_{ref} 1302 detects and measures a second target path 1411, 1412 (Y_{UE-target-TRP}_{_{ref}}) corresponding to the second target 1401, which includes LOS path 1411 and LOS path 1412. A difference between the two target paths results in Eq. 22:

$${Y}_{UE - target - {TRP}_{1}} - {Y}_{UE - target - {TRP}_{ref}} = ‖ {P}_{UE} - {x}_{1} ‖ + ‖ {P}_{{TRP}_{1}} - {x}_{1} ‖ - ‖ {P}_{UE} - {x}_{2} ‖ - ‖ {P}_{{TRP}_{ref}} - {x}_{2} ‖ \qquad ( Eq . 22 )$$

Unlike Eq. 21, Eq. 22 is dependent on the position P_{UE} of UE 1301 and is a function of the positions x₁, x₂ of the first and second targets 1304, 1401, respectively. In the second example, since the observing sensing node, TRP₁ 1303, and the reference sensing node, TRP_{ref} 1302, are observing two different targets, there may be no clear indications in the target path measurements regarding to which target 1304, 1401 the target path measurements are associated. To address this association ambiguity, the SnMF 600 may utilize existing outlier rejection techniques that consider measurements from other nodes to obtain additional information to assist in identifying the target to which a target path measurement is associated. For example, the SnMF 600 may configure the observing and reference sensing nodes to report a quasi co-location (QCL) indication with one or more target path measurements. The QCL indication would be associated with the corresponding target path and with the transmitting node/sensing node pair. The QCL may indicate the transmit reference signal and the receive reference signal that can be used to observe the corresponding target path. The QCL indication may provide information relating to an orientation of the transmit or receive beam for a target path measurement, which may assist the SnMF 600 in determining to which target a target path measurement may correspond. The same technique may be applied to DL and SL transmissions.

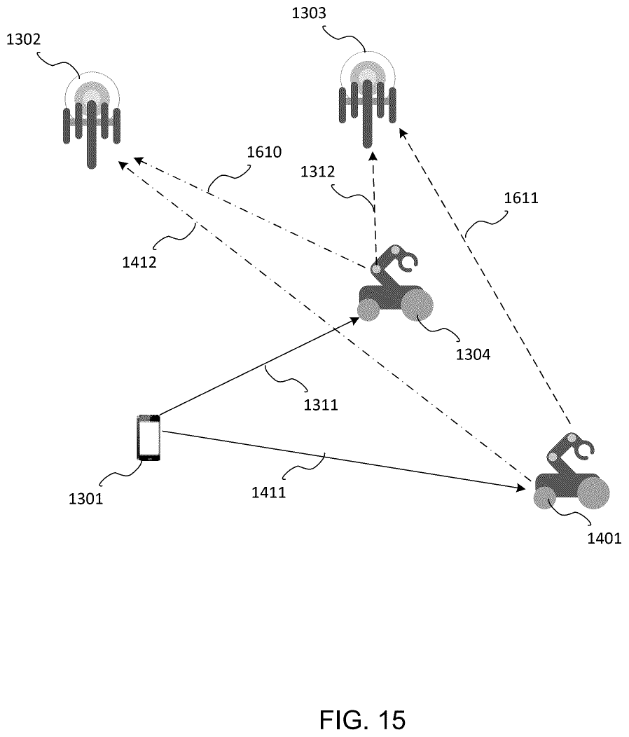

Referring to FIG. 15, in a third example of the third embodiment, the SnMF 600 may configure a sensing session where the observing sensing node and the reference sensing node observe the same multiple targets. The sensing session may include the UE 1301 with known or unknown position P_{UE}, the first TRP (TRP₁) 1303 with a known position P_{TRP1}, the second TRP (TRP_{ref}) 1302 with a known position P_{TRPref}, the first target 1304 with an unknown position x₁, and the second target 1401 with an unknown position x₂. The UE 1301 may be configured as the transmitting node, TRP₁ 1303 may be configured as the observing sensing node that observes both the first target 1304 and the second target 1401. TRP_{ref} 1302 may be configured as the reference sensing node that observes both the first target 1304 and the second target 1401. The UE 1301 has an LOS with the first target 1304 and the second target 1401, but no LOS with TRP_{ref} 1302 or TRP₁ 1303. TRP₁ 1303 has an LOS with the first target 1304 and the second target 1401, but no LOS with the UE 1301 or TRP_{ref} 1302. TRP_{ref} 1302 has LOS with the first target 1304 and the second target 1401, but no LOS with the UE 1301 or TRP₁ 1303. TRP₁ 1303 detects and measures a target path 1311, 1312 (Y_{UE-target-TRP}_{_{1,1}}) corresponding to the first target 1304, and a target path 1411, 1611 (Y_{UE-target-TRP}_{_{1,2}}) corresponding to the second target 1401. TRP_{ref} 1302 detects and measures a target path 1311, 1610 (Y_{UE-target-TRP}_{_{ref,1}}) corresponding to the first target 1304 and a target path 1411, 1412 (Y_{UE-target-TRP}_{_{ref,2}}) corresponding to the second target 1401. In this third example, four TRTOAs may be measured:

$$( 1 ) {Y}_{UE - target - {TRP}_{1 , 1}} - {Y}_{UE - target - {TRP}_{ref , 1}} = {TRTOA}_{1} \qquad ( Eq . 23 )$$

$$( 2 ) {Y}_{UE - target - {TRP}_{1 , 2}} - {Y}_{UE - target - {TRP}_{ref , 1}} = {TRTOA}_{1} + ( {Y}_{UE - target - {TRP}_{1 , 2}} - {Y}_{UE - target - {TRP}_{1 , 1}} ) = {TRTOA}_{1} + {TRTD}_{UE , {TRP}_{1} , 2 , 1} \qquad ( Eq . 24 )$$

$$( 3 ) {Y}_{UE - target - {TRP}_{1 , 1}} - {Y}_{UE - target - {TRP}_{ref , 2}} = {TRTOA}_{1} + {TRTD}_{UE , {TRP}_{ref} , 2 , 1} \qquad ( Eq . 25 )$$

$$( 4 ) {Y}_{UE - target - {TRP}_{1 , 1}} - {Y}_{UE - target - {TRP}_{ref , 2}} = {TRTOA}_{1} + {TRTD}_{UE , {TRP}_{ref} , 2 , 1} + {TRTD}_{UE , {TRP}_{1} , 2 , 1} \qquad ( Eq . 26 )$$

where
Y_{UE-target-TRP}_{_{1,1}} is a first target path from the UE 1301, reflected by either the first or second target 1304, 1401, and received by TRP₁ 1303 (i.e., either target path 1311,1312 or target path 1411,1611);
Y_{UE-target-TRP}_{_{1,2}} is a second target path from the UE 1301, reflected by either the first or second target 1304, 1401 and received by TRP₁ 1303 (i.e., either target path 1411,1611 or target path 1311, 1312);
Y_{UE-target-TRP}_{_{ref,1}} is a third target path from the UE 1301, reflected by either the first or second target 1304, 1401, and received by TRP_{ref} 1302 (i.e., either target path 1311, 1610 or target path 1411, 1412); and
Y_{UE-target-TRP}_{_{ref,2}} is a fourth target path from the UE 1301, reflected by either the first or second target 1304, 1401, and received by TRP_{ref} 1302 (i.e., either target path 1411, 1412 or target path 1311, 1610).
   To save network resources, instead of reporting the absolute values for each of the four TRTOAs, the absolute value for the first TRTOA (Eq. 22) may be reported, while differential reporting may be used Eqs. 24 and 25, where:
TRTD_{UE,TRP}_{_{1,}}_{2,1} is the difference between the time a reference signal of the target path 1311, 1312 arrives at TRP₁ 1303 and the time a reference signal of the target path 1411, 1611 arrives at TRP₁ 1303;
TRTD_{UE,TRP}_{_{ref}}_{,2,1} is the difference between the time a reference signal of the target path 1311, 1610 arrives at TRP_{ref} 1302 and the time a reference signal of the target path 1411, 1412 arrives at TRP_{ref} 1302. The SnMF 600 may construct the values of the second and third TRTOAs (Eqs. 24 and 25) using TRTOA₁, TRTD_{UE,TRP}_{_{1,}}_{2,1}, and TRTD_{UE,TRP}_{_{ref}}_{,2,1}. The SnMF 600 may construct the value of the fourth TRTOA (Eq. 26) using the sum of the other three TRTOA's (i.e., sum of Eqs. 23, 24, and 25). Thus, for the four TRTOA's, only the first TRTOA (Eq. 23) and two TRTD's (Eq. 24 and 25) need to be reported to the SnMF 600, saving network resources. As in the second example shown in FIG. 14, the target path measurements obtained by TRP_{ref} 1302 and TRP₁ 1303 may lack a clear indication of which target path measurement is associated with which target. The SnMF 600 may utilize existing outlier rejection techniques that consider measurements from other nodes to obtain additional information to assist in identifying the target to which a target path measurement is associated, as explained above with reference to FIG. 14. The same technique may be applied to DL and SL transmissions.

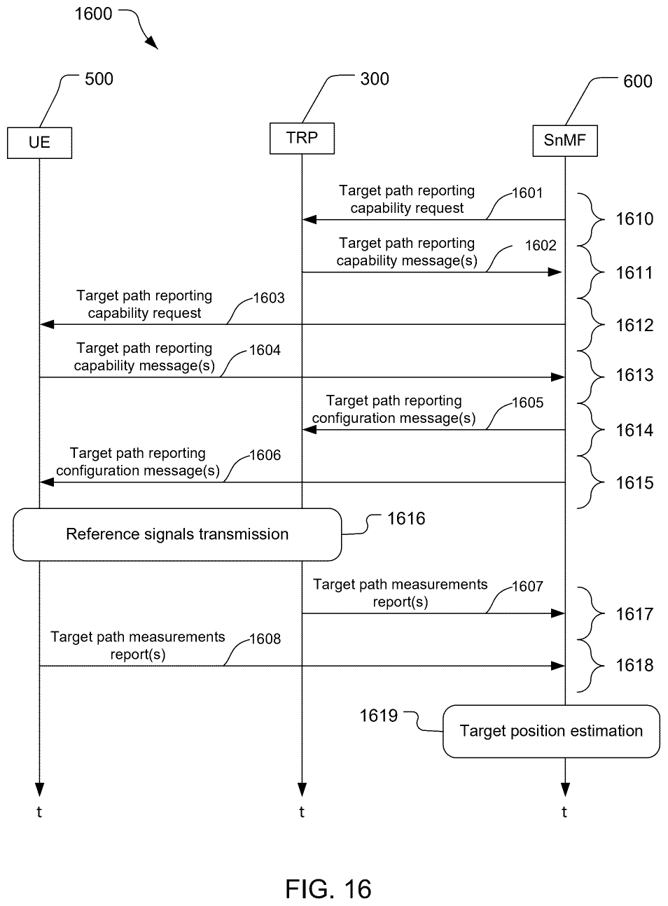

Referring to FIG. 16, a signal and processing flow 1600 for determining a target position estimation using RF sensing includes the stages shown. The flow 1600 is an example flow and not limiting. The flow 1600 may be altered, e.g., by having one or more messages and/or one or more stages added, removed, rearranged, combined, performed concurrently, and/or having one or more messages and/or one or more stages split into multiple messages and/or stages.

In stage 1610, the SnMF 600 may send one or more target path reporting capability requests 1601 to one or more TRP's 300 configured as one or more sensing nodes (e.g., TRP 702, 1002, 1003, 1302, 1303, and/or 1305) to request information on the TRP's capabilities for measuring and reporting target path measurements (e.g., TRTOA, TRSTD, TRTOA^{{LOS}}, TRSTD^{{LOS}}, and/or TRDT) corresponding to one or more target paths. In stage 1611, the one or more TRP's 300 may respond to the request 1601 by sending one or more target path reporting capability indications 1602 to the SnMF 600 with the TRP's 300 capabilities of measuring and reporting target path measurements corresponding to one or more target paths.

In stage 1612, the SnMF 600 may send one or more target path reporting capability requests 1603 to one or more UE's 500 that may be configured as one or more sensing node (e.g., 701, 901, 1001, and/or 1301) to request information on the UE's capabilities for measuring and reporting target path measurements corresponding to one or more target paths.

In stage 1613, the one or more UE's 500 may respond to the request 1603 by sending one or more target path reporting capability messages 1604 to the SnMF 600 with the UE's capabilities of measuring and reporting target path measurements corresponding to one or more target paths. The target path reporting capability messages 1602 from the TRP 300 may indicate the maximum number of supported target path measurement values that can be measured and reported by the TRP 300. The target path reporting capability messages 1604 from the UE 500 may indicate the maximum number of supported target path measurement values that can be measured and reported by the UE 500.

In stage 1614, the SnMF 600 may send one or more target path reporting configuration messages 1605 to the one or more TRP's 300 to configure one or more TRP's 300 as one or more sensing nodes and to configure the target path measurements corresponding to one or more target paths to report to the SnMF 600. The configuration may specify the reference signals to be measured and their structure (e.g., time/frequency resources) and the number of maximum TRTOA/TRSTD/TRTD paths to be reported.

In stage 1615, the SnMF 600 may send one or more target path reporting configuration messages 1606 to the one or more UE's 500 to configure the one or more UE's 500 as one or more sensing nodes and to configure the target path measurements corresponding to one or more target paths to report to the SnMF 600. The configuration may specify the reference signals to be measured and their structure (e.g., time/frequency resources) and the number of maximum TRTOA/TRSTD/TRTD paths to be reported.

In stage 1616, one or more UE's 500 and/or one or more TRP's 300 configured as one or more transmitting nodes may transmit reference signals to the one or more UE's 500 and/or the one or more TRP's 300 configured as one or more sensing nodes.

In stage 1617, one or more TRP's 300 configured as one or more sensing nodes may obtain one or more target path measurements corresponding to one or more target paths and may send one or more target path measurement reports 1607 to the SnMF 600, according to the one or more TRP's 300 respective capabilities.

In stage 1618, the one or more UE's 500 configured as one or more sensing nodes may obtain one or more target path measurements corresponding to one or more target paths and may send one or more target path measurement reports 1608 to the SnMF 600, according to the one or more UE's 500 respective capabilities.

In stage 1619, the SnMF 600 performs target position estimations based on the one or more target path measurement reports 1607 and/or 1608 received from the one or more TRP's 300 and/or one or more UE's 500 configured as sensing nodes.

In the target path reporting configuration messages 1605, 1606, the SnMF 600 may configure conditions or restrictions of the one or more target paths to be considered for the one or more target path measurement reports, where only the target path measurements that meet the conditions or restrictions are reported to the SnMF 600. For example, a restrictions for a minimum and/or maximum delay for the reporting, restrictions for a minimum target path power, and/or restrictions on an angle of arrival of a target path may be configured.

In the target path reporting configuration messages 1605, 1606, the SnMF 600 may further configure one or more sensing nodes to report a QCL indication with one or more target path measurements, which may be used to associate one or more target path measurements with one or more transmitting node/sensing node pairs. The QCL may assist the SnMF 600 in determining to which observed target a target path measurement may correspond.

In the target path reporting configuration messages 1605, 1606, and for the second and third embodiments, the SnMF 600 may configure a subset of TRP's 300 in a sensing session to be clock synchronized as a group, and configure another subset of TRP's 300 in the same sensing session to be clock synchronized as another group. For example, the SnMF 600 may configure the TRP_{ref} (e.g., TRP_{ref} 1002 and/or 1302) in each group as a function of the TRP identity. As an example, for the second embodiment, since TRP_{ref} (e.g., TRP_{ref} 1002 and/or 1302) has LOS with the UE (e.g., UE 1001 and/or 1301), the SnMF 600 may configure the TRP_{ref} identity as a function of the UE position P_{UE}, as an example for the third embodiment, since the target (e.g., target 1304 and/or 1401) has LOS with TRP_{ref} 1302 and the UE 1301, the SnMF 600 may configure the TRP_{ref} identity as a function of the UE position P_{UE}, as an example for the second and third embodiments, if more than one TRP_{ref} is configured for a sensing session, the SnMF 600 may configure the TRP_{ref} identity as a function of the TRP₁ identity (e.g., identity of TRP₁ 1003 and/or 1303) and the UE location.

In the target path reporting configuration messages 1605, 1606, and for the second and third embodiments, the SnMF 600 may configure more than one TRP_{ref} to provide redundancy or to improve performance based on an availability of multiple measurements. For example, if one TRP_{ref} does not observe any targets, measurements from other TRP_{ref} may be used.

In the target path reporting configuration messages 1605, 1606, and for the second and third embodiments, the SnMF 600 may specify the TRP 300 that is to function as the reference TRP (TRP_{ref}). Alternatively, the TRP_{ref} may be selected by the gNB 110b for UL transmission, or performed by the UE 105 for DL transmissions, with the gNB 110b or UE 105 reporting the identities of the TRP_{ref} for each assisting TRP-UE pair (e.g., TRP₁ 1003 and UE 1001, or TRP₁ 1303 and UE 1301) to the SnMF 600. As an example for the third embodiment, if the sensing session includes an association ambiguity as described above with reference to FIG. 14, the SnMF 600 may derive the observing TRP-transmitting UE pairs itself, or the SnMF 600 may be configured with the ability of change the reference path, i.e., select a different TRP_{ref}. The SnMF 600 may configure the new TRP_{ref} to report the absolute time (i.e., the TRTOA/TRSTD) of the first target path to arrive, and to report the TRTD for subsequent target paths to arrive, from which the SnMF 600 may derive the TRTOA/TRSTD of the subsequent target paths.

In the target path reporting configuration messages 1605, 1606, and for the second and third embodiments, if the observing sensing node does not detect any target paths in a signal, the SnMF 600 may configure the observing sensing node to return an empty set for the measurements corresponding to the reference signal. Alternatively, the SnMF 600 may configure the observing sensing node to not report any measurements for the reference signal, with the SnMF 600 configured to interpret the lack of reported measurements as the observing sensing node as detecting no target paths on the reference signal.

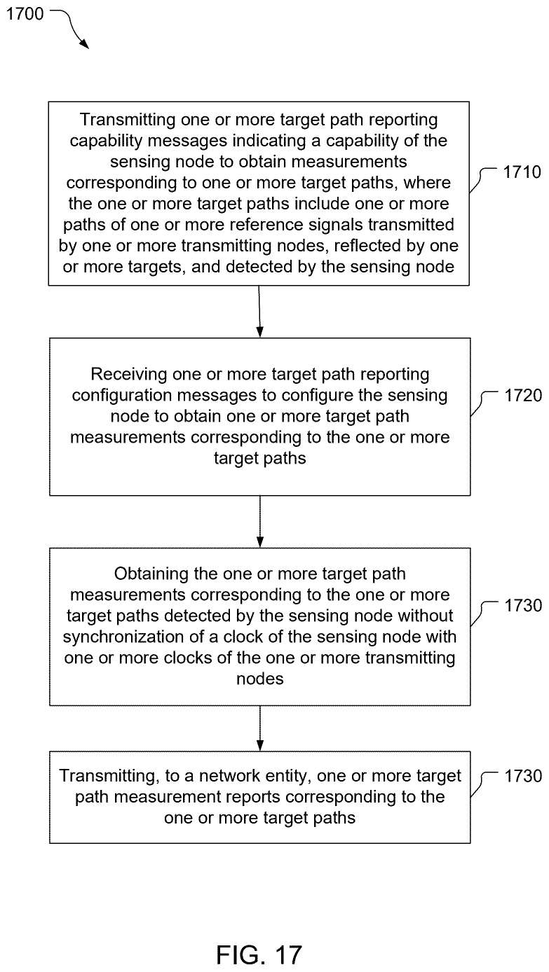

Referring to FIG. 17, a method 1700 for configuring a sensing node for a sensing session includes the stages shown. The method 1700 is, however, an example only and not limiting. The method 1700 may be altered, e.g., by having one or more stages added, removed, rearranged, combined, performed concurrently, and/or by having one or more single stages split into multiple stages.

At stage 1710, the method 1700 includes transmitting one or more target path reporting capability messages indicating a capability of the sensing node to obtain measurements corresponding to one or more target paths, where the one or more target paths include one or more paths of one or more reference signals transmitted by one or more transmitting nodes, reflected by one or more targets, and detected by the sensing node. The one or more processors (e.g., 310 and/or 510) in combination with the one or more memories (e.g., 311 and/or 530) provide means for transmitting a target path reporting capability message indicating a capability of the sensing node to obtain measurements corresponding to one or more target paths, where the one or more target paths include one or more paths of one or more reference signals transmitted by one or more transmitting nodes, reflected by one or more targets, and detected by the sensing node.

At stage 1720, the method 1700 includes receiving one or more target path reporting configuration messages to configure the sensing node to obtain one or more target path measurements corresponding to the one or more target paths. The one or more processors (e.g., 310 and/or 510) in combination with the one or more memories (e.g., 311 and/or 530) provide means for receiving one or more target path reporting configuration messages to configure the sensing node to obtain one or more measurements corresponding to the one or more target paths.

At stage 1730, the method 1700 includes obtaining the one or more target path measurements corresponding to the one or more target paths without synchronization of the clock of the sensing node with one or more clocks of the one or more transmitting nodes. The one or more processors (e.g., 310 and/or 510) in combination with the one or more memories (e.g., 311 and/or 530) provide means for obtaining the one or more target path measurements corresponding to the one or more target paths without synchronization of the clock of the sensing node with one or more clocks of the one or more transmitting nodes.

At stage 1740, the method 1700 includes transmitting to a network entity one or more target path measurement reports corresponding to the one or more target paths. The one or more processors (e.g., 310 and/or 510) in combination with the one or more memories (e.g., 311 and/or 530) provide means for transmitting to a network entity one or more target path measurement reports corresponding to the one or more target paths.

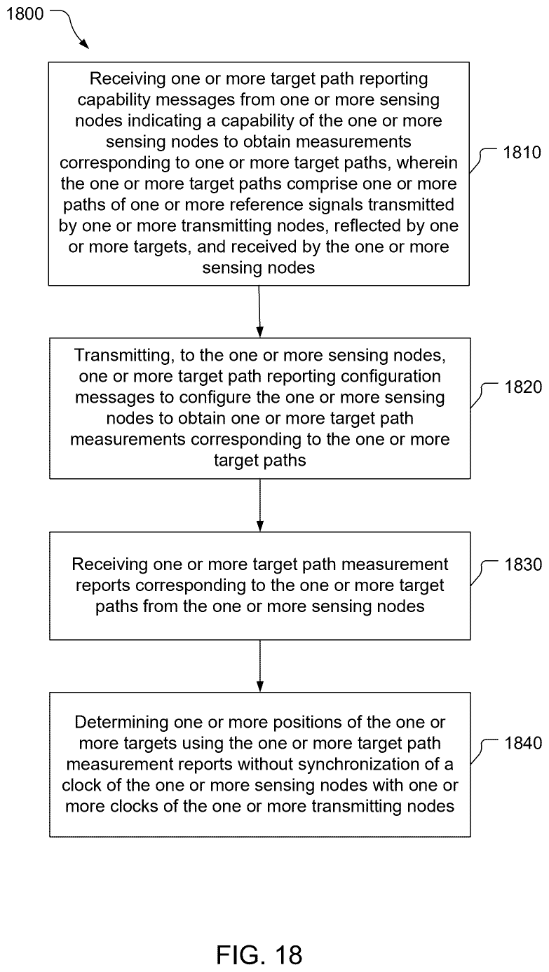

Referring to FIG. 18, a method 1800 for determining a position of a target includes the stages shown. The method 1800 is, however, an example only and not limiting. The method 1800 may be altered, e.g., by having one or more stages added, removed, rearranged, combined, performed concurrently, and/or by having one or more single stages split into multiple stages.

At stage 1810, the method 1800 includes receiving one or more target path reporting capability messages from one or more sensing nodes indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes. The one or more processors 610 in combination with the one or more memories 630 provide means for receiving one or more target path reporting capability messages from one or more sensing nodes indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes.

At stage 1820, the method 1800 includes transmitting, to the one or more sensing nodes, one or more target path reporting configuration messages to configure the one or more sensing nodes to obtain one or more target path measurements corresponding to the one or more target paths. The one or more processors 610 in combination with the one or more memories 630 provide means for includes transmitting, to the one or more sensing nodes, one or more target path reporting configuration messages to configure the one or more sensing nodes to obtain one or more measurements corresponding to the one or more target paths.

At stage 1830, the method 1800 includes receiving one or more target path measurement reports corresponding to the one or more target paths from the one or more sensing nodes. The one or more processors 610 in combination with the one or more memories 630 provide means for receiving one or more target path measurement reports corresponding to the one or more target paths from the one or more sensing nodes.

At stage 1840, the method 1800 includes determining one or more positions of the one or more targets using the one or more target path measurement reports without synchronization of the clock of the one or more sensing nodes with one or more clocks of the one or more transmitting nodes. The one or more processors 610 in combination with the one or more memories 630 provide means for determining one or more positions of the one or more targets using the one or more target path measurement reports without synchronization of the clock of the one or more sensing nodes with one or more clocks of the one or more transmitting nodes.

### Implementation Examples

Implementation examples are provided in the following numbered clauses.

Clause 1. A sensing node, comprising: one or more memories; a clock; one or more transceivers; and one or more processors, communicatively coupled to the one or more memories and the one or more transceivers, configured to: transmit, via the one or more transceivers, one or more target path reporting capability messages indicating a capability of the sensing node to obtain measurements corresponding to one or more target paths, wherein the one or more target paths comprise one or more paths of one or more reference signals transmitted by one or more transmitting nodes, reflected by one or more targets, and detected by the sensing node; receive, via the one or more transceivers, one or more target path reporting configuration messages to configure the sensing node to obtain one or more target path measurements corresponding to the one or more target paths; obtain the one or more target path measurements corresponding to the one or more target paths without synchronization of the clock of the sensing node with one or more clocks of the one or more transmitting nodes; and transmit, to a network entity via the one or more transceivers, one or more target path measurement reports corresponding to the one or more target paths.

Clause 2. The sensing node of clause 1, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, wherein one or more positions of the one or more transmitting nodes are known for the sensing session, and wherein a position of the sensing node is known for the sensing session.

Clause 3. The sensing node of clause 2, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.

Clause 4. The sensing node of clause 3, wherein, for a second target path of the one or more target paths, the one or more target path measurements comprise a difference between the time the first reference signal arrives at the sensing node and a time a third reference signal of the second target path arrives at the sensing node.

Clause 5. The sensing node of clause 4, wherein the first target path corresponds to a first target of the one or more targets, and wherein the second target path corresponds to a second target of the one or more targets.

Clause 6. The sensing node of clause 1, wherein the one or more target path reporting configuration messages configure the sensing node to obtain the one or more target path measurements during a sensing session, wherein the sensing session is configured with no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is synchronized with one or more clocks of the one or more reference sensing nodes.

Clause 7. The sensing node of clause 6, wherein for a first target path of the one or more target paths, the one or more target path measurements comprise a difference between a time a first reference signal of the first target path arrives at the sensing node and a time a second reference signal of the LOS path between the one or more transmitting nodes and the one or more reference sensing nodes arrives at the one or more reference sensing nodes.

Clause 8. The sensing node of clause 7, wherein for a second target path of the one or more target paths, the one or more target path measurements further comprise a difference between the time the first reference signal arrives at the sensing node and a time a third reference signal of a second target path arrives at the sensing node.

Clause 9. The sensing node of clause 8, wherein the first target path corresponds to a first target of the one or more targets, wherein the second target path corresponds to a second target of the one or more targets.

Clause 10. The sensing node of clause 1, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is synchronized with one or more clocks of the one or more reference sensing nodes.

Clause 11. The sensing node of clause 10, wherein for a target path of the one or more target paths, the one or more target path measurements comprise a difference between (1) a time a first reference signal of the target path arrives at the sensing node and (2) a time a second reference signal of the one or more LOS paths between the one or more transmitting nodes and the one or more reflectors and the one or more LOS paths between the one or more reflectors and the one or more reference sensing nodes arrives at the one or more reference sensing nodes.

Clause 12. The sensing node of clause 1, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node are known for the sensing session, and wherein the clock of the sensing node is synchronized with one or more clocks of the one or more reference sensing nodes.

Clause 13. The sensing node of clause 12, wherein, for a first target path of the one or more target paths, the one or more target path measurements comprise a difference between a time a first reference signal of the first target path arrives at the sensing node and a time a second reference signal of a second target path arrives at the one or more reference sensing nodes.

Clause 14. The sensing node of clause 13, wherein the sensing node and the one or more reference sensing nodes observe a same target of the one or more targets.

Clause 15. The sensing node of clause 13, wherein the sensing node and the one or more reference sensing nodes observe different targets, and wherein the one or more target path measurements comprise one or more indications of which target the one or more target path measurements correspond to.

Clause 16. The sensing node of clause 12, wherein the one or more target path reporting configuration messages configure the sensing node to detect a first target path corresponding to a first target of the one or more targets and a second target path corresponding to a second target of the one or more targets, wherein a reference sensing node of the one or more reference sensing nodes are configured to detect a third target path corresponding to the first target and a fourth target path corresponding to the second target, and wherein the one or more target path measurements comprise: a first target path measurement comprising a difference between a time a reference signal of the first target path arrives at the sensing node and a time a reference signal of the third target path arrives at the reference sensing node; a second target path measurement comprising a difference between a time a reference signal of the second target path arrives at the sensing node and the time the reference signal of the first target path arrives at the sensing node; and a third target path measurement comprising a difference between a time a reference signal of the fourth target path arrives at the reference sensing node and the time the reference signal of the third target path arrives at the reference sensing node.

Clause 17. A method for configuring a sensing node for a sensing session, comprising: transmitting one or more target path reporting capability messages indicating a capability of the sensing node to obtain measurements corresponding to one or more target paths, wherein the one or more target paths comprise one or more paths of one or more reference signals transmitted by one or more transmitting nodes, reflected by one or more targets, and detected by the sensing node; receiving one or more target path reporting configuration messages to configure the sensing node to obtain one or more target path measurements corresponding to the one or more target paths; obtaining the one or more target path measurements corresponding to the one or more target paths detected by the sensing node without synchronization of a clock of the sensing node with one or more clocks of the one or more transmitting nodes; and transmitting, to a network entity, one or more target path measurement reports corresponding to the one or more target paths.

Clause 18. The method of clause 17, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, wherein one or more positions of the one or more transmitting nodes are known for the sensing session, and wherein a position of the sensing node is known for the sensing session.

Clause 19. The method of clause 17, wherein the one or more target path reporting configuration messages configure the sensing node to obtain the one or more target path measurements during a sensing session, wherein the sensing session is configured with no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is synchronized with one or more clocks of the one or more reference sensing nodes.

Clause 20. The method of clause 17, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is synchronized with one or more clocks of the one or more reference sensing nodes.

Clause 21. The method of clause 17, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node are known for the sensing session, and wherein the clock of the sensing node is synchronized with one or more clocks of the one or more reference sensing nodes.

Clause 22. A sensing node, comprising: means for transmitting one or more target path reporting capability messages indicating a capability of the sensing node to obtain measurements corresponding to one or more target paths, wherein the one or more target paths comprise one or more paths of one or more reference signals transmitted by one or more transmitting nodes, reflected by one or more targets, and detected by the sensing node; means for receiving one or more target path reporting configuration messages to configure the sensing node to obtain one or more target path measurements corresponding to the one or more target paths; means for obtaining the one or more target path measurements corresponding to the one or more target paths detected by the sensing node without synchronization of the clock of the sensing node with one or more clocks of the one or more transmitting nodes; and means for transmitting, to a network entity, one or more target path measurement reports corresponding to the one or more target paths.

Clause 23. The sensing node of clause 22, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, wherein one or more positions of the one or more transmitting nodes are known for the sensing session, and wherein a position of the sensing node is known for the sensing session.

Clause 24. The sensing node of clause 22, wherein the one or more target path reporting configuration messages configure the sensing node to obtain the one or more target path measurements during a sensing session, wherein the sensing session is configured with no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is synchronized with one or more clocks of the one or more reference sensing nodes.

Clause 25. The sensing node of clause 22, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is synchronized with one or more clocks of the one or more reference sensing nodes.

Clause 26. The sensing node clause 22, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node are known for the sensing session, and wherein the clock of the sensing node is synchronized with one or more clocks of the one or more reference sensing nodes.

Clause 27. A non-transitory, processor-readable storage medium comprising processor-readable instructions to cause one or more processors of a sensing node to: transmit one or more target path reporting capability messages indicating a capability of the sensing node to obtain measurements corresponding to one or more target paths, wherein the one or more target paths comprise one or more paths of one or more reference signals transmitted by one or more transmitting nodes, reflected by one or more targets, and detected by the sensing node; receive one or more target path reporting configuration messages to configure the sensing node to obtain one or more target path measurements corresponding to the one or more target paths; obtain the one or more target path measurements corresponding to the one or more target paths detected by the sensing node without synchronization of the clock of the sensing node with one or more clocks of the one or more transmitting nodes; and transmit, to a network entity, one or more target path measurement reports corresponding to the one or more target paths.

Clause 28. The medium of clause 27, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, wherein one or more positions of the one or more transmitting nodes are known for the sensing session, and wherein a position of the sensing node is known for the sensing session.

Clause 29. The medium of clause 27, wherein the one or more target path reporting configuration messages configure the sensing node to obtain the one or more target path measurements during a sensing session, wherein the sensing session is configured with no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is synchronized with one or more clocks of the one or more reference sensing nodes.

Clause 30. The medium of clause 27, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is synchronized with one or more clocks of the one or more reference sensing nodes.

Clause 31. The medium of clause 27, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node are known for the sensing session, and wherein the clock of the sensing node is synchronized with one or more clocks of the one or more reference sensing nodes.

Clause 32. A network entity, comprising: one or more memories; one or more transceivers; and one or more processors, communicatively coupled to the one or more memories and the one or more transceivers, configured to: receive, via the one or more transceivers, one or more target path reporting capability messages from one or more sensing nodes indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes; transmit, to the one or more sensing nodes via the one or more transceivers, one or more target path reporting configuration messages to configure the one or more sensing nodes to obtain one or more target path measurements corresponding to the one or more target paths; receive, via the one or more transceivers, one or more target path measurement reports corresponding to the one or more target paths from the one or more sensing nodes; and determine one or more positions of the one or more targets using the one or more target path measurement reports corresponding to the one or more target paths without synchronization of a clock of the one or more sensing nodes with one or more clocks of the one or more transmitting nodes.

Clause 33. The network entity of clause 32, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, one or more LOS paths between the sensing node and the one or more targets, and one or more LOS paths between the one or more transmitting nodes and the one or more targets, wherein one or more positions of the one or more transmitting nodes are known for the sensing session, and wherein a position of the sensing node is known for the sensing session.

Clause 34. The network entity of clause 33, wherein the one or more processors configured to determine the one or more positions of the one or more targets using the one or more target path measurement reports corresponding to the one or more target paths are further configured to: determine the one or more positions of the one or more targets using the one or more target path measurement reports, the one or more positions of the one or more transmitting nodes, and the position of the sensing node.

Clause 35. The network entity of clause 33, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.

Clause 36. The network entity of clause 35, wherein, for a second target path of the one or more target paths, the one or more target path measurements comprise a difference between the time the first reference signal arrives at the sensing node and a time a third reference signal of the second target path arrives at the sensing node.

Clause 37. The network entity of clause 32, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is configured to be synchronized with one or more clocks of the one or more reference sensing nodes.

Clause 38. The network entity of clause 37, wherein the one or more processors configured to determine the one or more positions of the one or more targets using the one or more target path measurement reports corresponding to the one or more target paths are further configured to: determine the one or more positions of the one or more targets using the one or more target path measurement reports, the one or more positions of the one or more transmitting nodes, the one or more positions of the one or more reference sensing nodes, and the position of the sensing node.

Clause 39. The network entity of clause 37, wherein for a first target path of the one or more target paths, the one or more target path measurements comprise a difference between a time a first reference signal of the first target path arrives at the sensing node and a time a second reference signal of the LOS path between the one or more transmitting nodes and the one or more reference sensing nodes arrives at the one or more reference sensing nodes.

Clause 40. The network entity of clause 39, wherein for a second target path of the one or more target paths, the one or more target path measurements further comprise a difference between the time the first reference signal arrives at the sensing node and a time a third reference signal of a second target path arrives at the sensing node.

Clause 41. The network entity of clause 32, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is configured to be synchronized with one or more clocks of the one or more reference sensing nodes.

Clause 42. The network entity of clause 41, wherein the one or more processors configured to determine the one or more positions of the one or more targets using the one or more target path measurement reports corresponding to the one or more target paths are further configured to: determine the one or more positions of the one or more targets using the one or more target path measurement reports, the one or more positions of the one or more transmitting nodes, the one or more positions of the one or more reference sensing nodes, the position of the sensing node, and the one or more positions of the one or more reflectors.

Clause 43. The network entity of clause 41, wherein for a target path of the one or more target paths, the one or more target path measurements comprise a difference between (1) a time a first reference signal of the target path arrives at the sensing node and (2) a time a second reference signal of the one or more LOS paths between the one or more transmitting nodes and the one or more reflectors and the one or more LOS paths between the one or more reflectors and the one or more reference sensing nodes arrives at the one or more reference sensing nodes.

Clause 44. The network entity of clause 32, wherein the one or more target path reporting configuration messages configure the sensing node to obtain the one or more target path measurements during a sensing session, wherein the sensing session is configured with one or more LOS paths between the sensing node and the one or more targets, one or more LOS paths between one or more reference sensing nodes and the one or more targets, one or more LOS paths between the one or more transmitting nodes and the one or more targets, no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node be known for the sensing session, and wherein the clock of the sensing node is configured to be synchronized with one or more clocks of the one or more reference sensing nodes.

Clause 45. The network entity of clause 44, wherein the one or more processors configured to determine the one or more positions of the one or more targets using the one or more target path measurement reports corresponding to the one or more target paths are further configured to: determine the one or more positions of the one or more targets using the one or more target path measurement reports, the one or more positions of the one or more reference sensing nodes and the position of the sensing node.

Clause 46. The network entity of clause 44, wherein, for a first target path of the one or more target paths, the one or more target path measurements comprise a difference between a time a first reference signal of the first target path arrives at the sensing node and a time a second reference signal of a second target path arrives at the one or more reference sensing nodes.

Clause 47. The network entity of clause 44, wherein the one or more target path reporting configuration messages configure the sensing node to detect a first target path corresponding to a first target of the one or more targets and a second target path corresponding to a second target of the one or more targets, wherein a reference sensing node of the one or more reference sensing nodes are configured to detect a third target path corresponding to the first target and a fourth target path corresponding to the second target, and wherein the one or more target path measurements comprise: a first target path measurement comprising a difference between a time a reference signal of the first target path arrives at the sensing node and a time a reference signal of the third target path arrives at the reference sensing node; a second target path measurement comprising a difference between a time a reference signal of the second target path arrives at the sensing node and the time the reference signal of the first target path arrives at the sensing node; and a third target path measurement comprising a difference between a time a reference signal of the fourth target path arrives at the reference sensing node and the time the reference signal of the third target path arrives at the reference sensing node.

Clause 48. A method for determining a position of a target, comprising: receiving, from one or more sensing nodes, one or more target path reporting capability messages indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes; transmitting, to the one or more sensing nodes, one or more target path reporting configuration messages to configure the one or more sensing nodes to obtain one or more target path measurements corresponding to the one or more target paths; receiving, from the one or more sensing nodes, one or more target path measurement reports corresponding to the one or more target paths; and determining one or more positions of the one or more targets using the one or more target path measurement reports corresponding to the one or more target paths without synchronization of a clock of the one or more sensing nodes with one or more clocks of the one or more transmitting nodes.

Clause 49. The method of clause 48, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, one or more LOS paths between the sensing node and the one or more targets, and one or more LOS paths between the one or more transmitting nodes and the one or more targets, wherein one or more positions of the one or more transmitting nodes are known for the sensing session, and wherein a position of the sensing node is known for the sensing session.

Clause 50. The method of clause 48, wherein the determining of the one or more positions of the one or more targets using the one or more target path measurement reports corresponding to the one or more target paths further comprise: determining the one or more positions of the one or more targets using the one or more target path measurement reports, the one or more positions of the one or more transmitting nodes, and the position of the sensing node.

Clause 51. The method of clause 48, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.

Clause 52. The method of clause 48, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is configured to be synchronized with one or more clocks of the one or more reference sensing nodes.

Clause 53. The method of clause 48, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is configured to be synchronized with one or more clocks of the one or more reference sensing nodes.

Clause 54. The method of clause 48, wherein the one or more target path reporting configuration messages configure the sensing node to obtain the one or more target path measurements during a sensing session, wherein the sensing session is configured with one or more LOS paths between the sensing node and the one or more targets, one or more LOS paths between one or more reference sensing nodes and the one or more targets, one or more LOS paths between the one or more transmitting nodes and the one or more targets, no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node be known for the sensing session, and wherein the clock of the sensing node is configured to be synchronized with one or more clocks of the one or more reference sensing nodes.

Clause 55. A network entity, comprising: means for receiving, from one or more sensing nodes, one or more target path reporting capability messages indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes; means for transmitting, to the one or more sensing nodes, one or more target path reporting configuration messages to configure the one or more sensing nodes to obtain one or more target path measurements corresponding to the one or more target paths; means for receiving, from the one or more sensing nodes, one or more target path measurement reports corresponding to the one or more target path measurements; and means for determining one or more positions of the one or more targets using the one or more target path measurement reports corresponding to the one or more target paths without synchronization of the clock of the one or more sensing nodes with one or more clocks of the one or more transmitting nodes.

Clause 56. The network entity of clause 55, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, one or more LOS paths between the sensing node and the one or more targets, and one or more LOS paths between the one or more transmitting nodes and the one or more targets, wherein one or more positions of the one or more transmitting nodes are known for the sensing session, and wherein a position of the sensing node is known for the sensing session.

Clause 57. The network entity of clause 55, wherein the means for determining the one or more positions of the one or more targets using the one or more target path measurement reports corresponding to the one or more target paths further comprise: means for determining the one or more positions of the one or more targets using the one or more target path measurement reports, the one or more positions of the one or more transmitting nodes, and the position of the sensing node.

Clause 58. The network entity of clause 55, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.

Clause 59. The network entity of clause 55, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is configured to be synchronized with one or more clocks of the one or more reference sensing nodes.

Clause 60. The network entity of clause 55, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is configured to be synchronized with one or more clocks of the one or more reference sensing nodes.

Clause 61. The network entity of clause 55, wherein the one or more target path reporting configuration messages configure the sensing node to obtain the one or more target path measurements during a sensing session, wherein the sensing session is configured with one or more LOS paths between the sensing node and the one or more targets, one or more LOS paths between one or more reference sensing nodes and the one or more targets, one or more LOS paths between the one or more transmitting nodes and the one or more targets, no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node be known for the sensing session, and wherein the clock of the sensing node is configured to be synchronized with one or more clocks of the one or more reference sensing nodes.

Clause 62. A non-transitory, processor-readable storage medium comprising processor-readable instructions to cause one or more processors of a network entity to: receive one or more target path reporting capability messages from one or more sensing nodes indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes; transmit, to the one or more sensing nodes, one or more target path reporting configuration messages to configure the one or more sensing nodes to obtain one or more target path measurements corresponding to the one or more target paths; receive one or more target path measurement reports corresponding to the one or more target paths from the one or more sensing nodes; and determine one or more positions of the one or more targets using the one or more target path measurement reports corresponding to the one or more target paths without synchronization of the clock of the one or more sensing nodes with one or more clocks of the one or more transmitting nodes.

Clause 63. The medium of clause 62, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, one or more LOS paths between the sensing node and the one or more targets, and one or more LOS paths between the one or more transmitting nodes and the one or more targets, wherein one or more positions of the one or more transmitting nodes are known for the sensing session, and wherein a position of the sensing node is known for the sensing session.

Clause 64. The medium of clause 62, wherein the one or more processors configured to determine the one or more positions of the one or more targets using the one or more target path measurement reports corresponding to the one or more target paths are further configured to: determine the one or more positions of the one or more targets using the one or more target path measurement reports, the one or more positions of the one or more transmitting nodes, and the position of the sensing node.

Clause 65. The medium of clause 62, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.

Clause 66. The medium of clause 62, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, and one or more LOS paths between the one or more transmitting nodes and the one or more reference sensing nodes, wherein one or more positions of the one or more transmitting nodes, one or more positions of one or more reference sensing nodes, and a position of the sensing node are known for the sensing session, and wherein the clock of the sensing node is configured to be synchronized with one or more clocks of the one or more reference sensing nodes.

Clause 67. The medium of clause 62, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes, wherein one or more positions of the one or more transmitting nodes, one or more positions of one or more reference sensing nodes, a position of the sensing node, and one or more positions of the one or more reflectors, are known for the sensing session, and wherein the clock of the sensing node is configured to be synchronized with one or more clocks of the one or more reference sensing nodes.

Clause 68. The medium of clause 62, wherein the one or more target path reporting configuration messages configure the sensing node to obtain the one or more target path measurements during a sensing session, wherein the sensing session is configured with one or more LOS paths between the sensing node and the one or more targets, one or more LOS paths between one or more reference sensing nodes and the one or more targets, one or more LOS paths between the one or more transmitting nodes and the one or more targets, no LOS path between the sensing node and one or more reference sensing nodes, no LOS path between the sensing node and the one or more transmitting nodes, no LOS path between the one or more transmitting nodes and the one or more reference sensing nodes, wherein one or more positions of one or more reference sensing nodes and a position of the sensing node be known for the sensing session, and wherein the clock of the sensing node is configured to be synchronized with one or more clocks of the one or more reference sensing nodes.

### Other Considerations

Other examples and implementations are within the scope of the disclosure and appended claims. For example, due to the nature of software and computers, functions described above can be implemented using software executed by one or more processors, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by one or more processors, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A sensing node, comprising:
one or more memories;
a clock;
one or more transceivers; and
one or more processors, communicatively coupled to the one or more memories and the one or more transceivers, configured to:
transmit, via the one or more transceivers, one or more target path reporting capability messages indicating a capability of the sensing node to obtain measurements corresponding to one or more target paths, wherein the one or more target paths comprise one or more paths of one or more reference signals transmitted by one or more transmitting nodes, reflected by one or more targets, and detected by the sensing node;
receive, via the one or more transceivers, one or more target path reporting configuration messages to configure the sensing node to obtain one or more target path measurements corresponding to the one or more target paths;
obtain the one or more target path measurements corresponding to the one or more target paths without synchronization of the clock of the sensing node with one or more clocks of the one or more transmitting nodes; and
transmit, to a network entity via the one or more transceivers, one or more target path measurement reports corresponding to the one or more target paths.

2. The sensing node of claim 1, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, wherein one or more positions of the one or more transmitting nodes are known for the sensing session, and wherein a position of the sensing node is known for the sensing session.

3. The sensing node of claim 2, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.

4. The sensing node of claim 3, wherein, for a second target path of the one or more target paths, the one or more target path measurements comprise a difference between the time the first reference signal arrives at the sensing node and a time a third reference signal of the second target path arrives at the sensing node.

5. The sensing node of claim 4, wherein the first target path corresponds to a first target of the one or more targets, and wherein the second target path corresponds to a second target of the one or more targets.

6. The sensing node of claim 1, wherein the one or more target path reporting configuration messages configure the sensing node to obtain the one or more target path measurements during a sensing session, wherein the sensing session is configured with no LOS path between the sensing node and the one or more transmitting nodes, and one or more LOS paths between the one or more transmitting nodes and the one or more reference sensing nodes,
wherein one or more positions of the one or more transmitting nodes, one or more positions of one or more reference sensing nodes, and a position of the sensing node are known for the sensing session, and
wherein the clock of the sensing node is synchronized with one or more clocks of the one or more reference sensing nodes.

7. The sensing node of claim 6, wherein for a first target path of the one or more target paths, the one or more target path measurements comprise a difference between a time a first reference signal of the first target path arrives at the sensing node and a time a second reference signal of the LOS path between the one or more transmitting nodes and the one or more reference sensing nodes arrives at the one or more reference sensing nodes.

8. The sensing node of claim 7, wherein for a second target path of the one or more target paths, the one or more target path measurements further comprise a difference between the time the first reference signal arrives at the sensing node and a time a third reference signal of a second target path arrives at the sensing node.

9. The sensing node of claim 8, wherein the first target path corresponds to a first target of the one or more targets, wherein the second target path corresponds to a second target of the one or more targets.

10. The sensing node of claim 1, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes,
wherein one or more positions of the one or more transmitting nodes, one or more positions of one or more reference sensing nodes, a position of the sensing node, and one or more positions of the one or more reflectors, are known for the sensing session, and
wherein the clock of the sensing node is synchronized with one or more clocks of the one or more reference sensing nodes.

11. The sensing node of claim 10, wherein for a target path of the one or more target paths, the one or more target path measurements comprise a difference between (1) a time a first reference signal of the target path arrives at the sensing node and (2) a time a second reference signal of the one or more LOS paths between the one or more transmitting nodes and the one or more reflectors and the one or more LOS paths between the one or more reflectors and the one or more reference sensing nodes arrives at the one or more reference sensing nodes.

12. The sensing node of claim 1, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes,
wherein one or more positions of one or more reference sensing nodes and a position of the sensing node are known for the sensing session, and
wherein the clock of the sensing node is synchronized with one or more clocks of the one or more reference sensing nodes.

13. The sensing node of claim 12, wherein, for a first target path of the one or more target paths, the one or more target path measurements comprise a difference between a time a first reference signal of the first target path arrives at the sensing node and a time a second reference signal of a second target path arrives at the one or more reference sensing nodes.

14. The sensing node of claim 13, wherein the sensing node and the one or more reference sensing nodes observe a same target of the one or more targets.

15. The sensing node of claim 13, wherein the sensing node and the one or more reference sensing nodes observe different targets, and wherein the one or more target path measurements comprise one or more indications of which target the one or more target path measurements correspond to.

16. The sensing node of claim 12, wherein the one or more target path reporting configuration messages configure the sensing node to detect a first target path corresponding to a first target of the one or more targets and a second target path corresponding to a second target of the one or more targets, wherein a reference sensing node of the one or more reference sensing nodes are configured to detect a third target path corresponding to the first target and a fourth target path corresponding to the second target, and wherein the one or more target path measurements comprise:
a first target path measurement comprising a difference between a time a reference signal of the first target path arrives at the sensing node and a time a reference signal of the third target path arrives at the reference sensing node;
a second target path measurement comprising a difference between a time a reference signal of the second target path arrives at the sensing node and the time the reference signal of the first target path arrives at the sensing node; and
a third target path measurement comprising a difference between a time a reference signal of the fourth target path arrives at the reference sensing node and the time the reference signal of the third target path arrives at the reference sensing node.

17. A method for configuring a sensing node for a sensing session, comprising:
transmitting one or more target path reporting capability messages indicating a capability of the sensing node to obtain measurements corresponding to one or more target paths, wherein the one or more target paths comprise one or more paths of one or more reference signals transmitted by one or more transmitting nodes, reflected by one or more targets, and detected by the sensing node;
receiving one or more target path reporting configuration messages to configure the sensing node to obtain one or more target path measurements corresponding to the one or more target paths;
obtaining the one or more target path measurements corresponding to the one or more target paths detected by the sensing node without synchronization of a clock of the sensing node with one or more clocks of the one or more transmitting nodes; and
transmitting, to a network entity, one or more target path measurement reports corresponding to the one or more target paths.

18. The method of claim 17, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, wherein one or more positions of the one or more transmitting nodes are known for the sensing session, and wherein a position of the sensing node is known for the sensing session.

19. The method of claim 17, wherein the one or more target path reporting configuration messages configure the sensing node to obtain the one or more target path measurements during a sensing session, wherein the sensing session is configured with no LOS path between the sensing node and the one or more transmitting nodes, and one or more LOS paths between the one or more transmitting nodes and the one or more reference sensing nodes,
wherein one or more positions of the one or more transmitting nodes, one or more positions of one or more reference sensing nodes, and a position of the sensing node are known for the sensing session, and
wherein the clock of the sensing node is synchronized with one or more clocks of the one or more reference sensing nodes.

20. The method of claim 17, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes,
wherein one or more positions of the one or more transmitting nodes, one or more positions of one or more reference sensing nodes, a position of the sensing node, and one or more positions of the one or more reflectors, are known for the sensing session, and
wherein the clock of the sensing node is synchronized with one or more clocks of the one or more reference sensing nodes.

21. The method of claim 17, wherein the one or more target path reporting configuration messages configure the sensing node to obtain the one or more target path measurements during a sensing session, wherein the sensing session is configured with no LOS path between the sensing node and one or more reference sensing nodes, no LOS path between the sensing node and the one or more transmitting nodes, no LOS path between the one or more transmitting nodes and the one or more reference sensing nodes,
wherein one or more positions of one or more reference sensing nodes and a position of the sensing node are known for the sensing session, and
wherein the clock of the sensing node is synchronized with one or more clocks of the one or more reference sensing nodes.

22. A network entity, comprising:
one or more memories; one or more transceivers; and
one or more processors, communicatively coupled to the one or more memories and the one or more transceivers, configured to:
receive, via the one or more transceivers, one or more target path reporting capability messages from one or more sensing nodes indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes;
transmit, to the one or more sensing nodes via the one or more transceivers, one or more target path reporting configuration messages to configure the one or more sensing nodes to obtain one or more target path measurements corresponding to the one or more target paths;
receive, via the one or more transceivers, one or more target path measurement reports corresponding to the one or more target paths from the one or more sensing nodes; and
determine one or more positions of the one or more targets using the one or more target path measurement reports corresponding to the one or more target paths without synchronization of a clock of the one or more sensing nodes with one or more clocks of the one or more transmitting nodes.

23. The network entity of claim 22, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, one or more LOS paths between the sensing node and the one or more targets, and one or more LOS paths between the one or more transmitting nodes and the one or more targets,
wherein one or more positions of the one or more transmitting nodes are known for the sensing session, and wherein a position of the sensing node is known for the sensing session.

24. The network entity of claim 22, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, and one or more LOS paths between the one or more transmitting nodes and the one or more reference sensing nodes,
wherein one or more positions of the one or more transmitting nodes, one or more positions of one or more reference sensing nodes, and a position of the sensing node are known for the sensing session, and
wherein the clock of the sensing node is configured to be synchronized with one or more clocks of the one or more reference sensing nodes.

25. The network entity of claim 22, wherein the one or more target path reporting configuration messages configure the sensing node to obtain the one or more target path measurements during a sensing session, wherein the sensing session is configured with one or more LOS paths between the sensing node and the one or more targets, no LOS path between the sensing node and one or more reference sensing nodes, no LOS path between the sensing node and the one or more transmitting nodes, no LOS path between the one or more transmitting nodes and the one or more reference sensing nodes, one or more LOS paths between the one or more transmitting nodes and one or more reflectors, and one or more LOS paths between the one or more reflectors and the one or more reference sensing nodes,
wherein one or more positions of the one or more transmitting nodes, one or more positions of one or more reference sensing nodes, a position of the sensing node, and one or more positions of the one or more reflectors, are known for the sensing session, and wherein the clock of the sensing node is configured to be synchronized with one or more clocks of the one or more reference sensing nodes.

26. The network entity of claim 22, wherein the one or more target path reporting configuration messages configure the sensing node to obtain the one or more target path measurements during a sensing session, wherein the sensing session is configured with one or more LOS paths between the sensing node and the one or more targets, one or more LOS paths between one or more reference sensing nodes and the one or more targets, one or more LOS paths between the one or more transmitting nodes and the one or more targets, no LOS path between the sensing node and one or more reference sensing nodes, no LOS path between the sensing node and the one or more transmitting nodes, no LOS path between the one or more transmitting nodes and the one or more reference sensing nodes,
wherein one or more positions of one or more reference sensing nodes and a position of the sensing node be known for the sensing session, and wherein the clock of the sensing node is configured to be synchronized with one or more clocks of the one or more reference sensing nodes.

27. A method for determining a position of a target, comprising:
receiving, from one or more sensing nodes, one or more target path reporting capability messages indicating a capability of the one or more sensing nodes to obtain measurements corresponding to one or more target paths, wherein the one or more target paths comprise one or more paths of one or more reference signals transmitted by one or more transmitting nodes, reflected by one or more targets, and received by the one or more sensing nodes;
transmitting, to the one or more sensing nodes, one or more target path reporting configuration messages to configure the one or more sensing nodes to obtain one or more target path measurements corresponding to the one or more target paths;
receiving, from the one or more sensing nodes, one or more target path measurement reports corresponding to the one or more target paths; and
determining one or more positions of the one or more targets using the one or more target path measurement reports corresponding to the one or more target paths without synchronization of a clock of the one or more sensing nodes with one or more clocks of the one or more transmitting nodes.

28. The method of claim 27, wherein the one or more target path reporting configuration messages configure the sensing node to obtain the one or more target path measurements during a sensing session, wherein the sensing session is configured with one or more line of sight (LOS) paths between the sensing node and the one or more transmitting nodes, one or more LOS paths between the sensing node and the one or more targets, and one or more LOS paths between the one or more transmitting nodes and the one or more targets, wherein one or more positions of the one or more transmitting nodes are known for the sensing session, and wherein a position of the sensing node is known for the sensing session.

29. The method of claim 27, wherein the determining of the one or more positions of the one or more targets using the one or more target path measurement reports corresponding to the one or more target paths further comprise:
determining the one or more positions of the one or more targets using the one or more target path measurement reports, the one or more positions of the one or more transmitting nodes, and the position of the sensing node.

30. The method of claim 27, wherein for a first target path of the one or more target paths, the one or more target path measurements comprise a difference between a time a first reference signal of the first target path arrives at the sensing node and a time a second reference signal of the one or more LOS paths between the sensing node and the one or more transmitting nodes arrives at the sensing node.
